(19) United States
(12) Patent Application Publication
(10) Pub. No.: US 2024/0198157 A1
(43) Pub. Date: Jun. 20, 2024

(54) PREPARATION OF A FOAM STABILIZING COMPOSITION INCLUDING A SILOXANE CATIONIC SURFACTANT AND A METAL SALT

(71) Applicant: Dow Silicones Corporation, Midland, MI (US)

(72) Inventors: Anirudha Banerjee, Midland, MI (US); Nanguo Liu, Midland, MI (US); Zachary Wenzlick, Midland, MI (US)

(21) Appl. No.: 18/553,854

(22) PCT Filed: Jun. 21, 2022
(86) PCT No.: PCT/US2022/073048

§ 371 Date: Oct. 4, 2023

Related U.S. Application Data
(60) Provisional application No. 63/218,941, filed on Jul. 7, 2021.

(51) Int. Cl. A62D 1/02; A62C 5/00; A62C 5/02

(52) U.S. Cl. CPC A62D 1/0071; A62C 5/002; A62C 5/02

(57) ABSTRACT

A foam stabilizing composition includes a) metal salt; b) a siloxane cationic surfactant and c) a cationic surfactant. The siloxane cationic surfactant includes a cationic moiety having the formula Z¹-D¹N(Y)ₐ(R)2-ₐ, where Z¹ is a siloxane moiety, D¹ is a divalent linking group, R is H or an unsubstituted hydrocarbyl group having from 1 to 4 carbon atoms, subscript a is 1 or 2, and each Y has formula -D-NR¹₃⁺, where D is a divalent linking group and each R¹ is independently an unsubstituted hydrocarbyl group having from 1 to 4 carbon atoms. A firefighting includes the foam stabilizing composition and water. Methods of making and using the same are also provided.

### CROSS REFERENCE TO RELATED APPLICATION

This application claims the benefit of U.S. Provisional Patent Application Ser. No. 63/218,941 filed on 7 Jul. 2021 under 35 U.S.C. § 119 (e). U.S. Provisional Patent Application Ser. No. 63/218,941 is hereby incorporated by reference.

### FIELD

A foam stabilizing composition and method for its preparation are provided. The foam stabilizing composition is suitable for use in forming an aqueous foam that can be used for firefighting applications.

### INTRODUCTION

Aqueous foams are highly effective for extinguishing class B (flammable liquid) fires, and have been used for this purpose for 40 to 50 years. The active ingredient in most aqueous foam used for firefighting is a perfluoroalkyl surfactant. An aqueous foam made with the perfluoroalkyl surfactant can smother a fire with a knockdown time (i.e., the time required to completely extinguish the fire) of less than 30 seconds. Additionally, once the fire is extinguished, the aqueous foam made with the perfluoroalkyl surfactant can prevent the fire from reigniting.

Due to many of the desired properties such as high chemical resistance, high hydrophobicity, and high lipophobicity, perfluoroalkyl substances (PFAS) have found wide-spread use. However, PFAS such as perfluoroalkyl surfactants, have been shown to decompose or otherwise degrade under environmental conditions to give numerous fluorochemicals, some of which have been found to be environmentally persistent. As such, PFAS are increasingly being phased out of production and use, leading to many widely utilized perfluoroalkyl surfactants and compositions containing them becoming unavailable for continued use.

Firefighting foam formulators have so far not identified a PFAS-free product that can deliver the same performance in fighting fires as the benchmark aqueous foam containing perfluoroalkyl surfactants. The PFAS-free products on the market are either too slow to spread on fire, or the foams are not stable long enough over the fuel to allow effective fire extinction. Some foams that work over fuel oil are not suitable for firefighting applications involving flammable solvents such as alcohols.

There is an industry need to provide firefighting foam, which are free of PFAS. More particularly, there is an industry need for a firefighting foam that is PFAS-free and that is stable over both polar and nonpolar fuels.

### SUMMARY

A foam stabilizing composition and method for its preparation are provided herein. The foam stabilizing composition comprises: a) a salt comprising a metal and an ion selected from the group consisting of a chloride ion and a sulfate ion, b) a siloxane cationic surfactant, and water. A firefighting foam comprising the foam stabilizing composition, and methods for preparation and use of the firefighting foam, are also provided.

### DETAILED DESCRIPTION

The foam stabilizing composition (composition) comprises a) the salt comprising the metal and the ion selected from the group consisting of the chloride ion and the sulfate ion, b) the siloxane cationic surfactant, and water. This composition may optionally further comprise one or more additional starting materials selected from the group consisting of c) an organic cationic surfactant, d) a carrier vehicle (i.e., other than water), e) an additional surfactant (i.e., a surfactant which may be cationic, nonionic or amphoteric, provided that e) the additional surfactant differs from starting materials b) and c), f) a rheology modifier, g) a pH control agent, and h) a foam enhancer. The carrier vehicle d) may comprise water, and the foam stabilizing composition typically comprises a) the salt, b) the siloxane cationic surfactant, and d) water. The foam stabilizing composition may be utilized in foam compositions (i.e., foams), including aqueous foam compositions, expanded foam compositions, concentrated foam compositions and/or foam concentrates, which may be formulated and/or utilized in diverse end-use applications. For example, the foam stabilizing composition described herein may be used to prepare a foam or foaming composition suitable for use in firefighting applications (i.e., extinguishing, suppressing, and/or preventing fire).

### Starting Material a) Salt

Starting material a) in the foam stabilizing composition is a salt comprising a metal and an ion selected from the group consisting of a chloride ion and a sulfate ion. When the ion is the chloride ion, starting material a) is a metal chloride salt. When the ion is the sulfate ion, starting material a) is a metal sulfate salt. The metal may be selected from the group consisting of Group 13 metals, Group 2 metals, and Group 1 metals of the IUPAC periodic table of the elements version dated 28 Nov. 2016. The Group 13 metal may be aluminum (Al). The Group 2 metal may be calcium (Ca) or magnesium (Mg). The Group 1 metal may be sodium (Na) or potassium (K).

The metal chloride salt used in the foam stabilizing composition may be selected from the group consisting of aluminum chloride (AlCl₃), calcium chloride (CaCl₂), magnesium chloride (MgCl₂), sodium chloride (NaCl), potassium chloride (KCl), and combinations of two or more thereof. Alternatively, the metal chloride salt may be any one of AlCl₃, CaCl₂), MgCl₂, NaCl, and KCl. Alternatively, the metal chloride salt may be AlCl₃. Alternatively, the metal chloride salt may be selected from the group consisting of CaCl₂, MgCl₂, and a combination thereof. Alternatively, the metal chloride salt may be selected from the group consisting of NaCl and KCl.

Alternatively, the metal sulfate salt used in the foam stabilizing composition may be selected from the group consisting of aluminum sulfate, calcium sulfate, magnesium sulfate, sodium sulfate, potassium sulfate, and combinations of two or more thereof. Alternatively, the salt may be any one of aluminum sulfate, calcium sulfate, magnesium sulfate, sodium sulfate, and potassium sulfate. Alternatively, the salt may be aluminum sulfate. Alternatively, the salt may be selected from the group consisting of calcium sulfate, magnesium sulfate, and a combination thereof. Alternatively, the salt may be selected from the group consisting of sodium sulfate, potassium sulfate, and a combination thereof. Alternatively, the metal sulfate salt may be calcium sulfate.

The salts described above are known in the art and are commercially available from various sources. The amount of the salt a) in the foam stabilizing composition depends on various factors including the species of the salt selected and other starting materials of the foam stabilizing composition, including for example, the source of water. For example, one skilled in the art would recognize that the amount of the salt may be adjusted depending on the end use of the foam stabilizing composition, e.g., if the foam stabilizing composition will be combined with tap water or city water to prepare the foam, the amount of salt may be higher than if the foam stabilizing composition will be combined with sea water, which may contains ions including chloride (Cl⁻), sodium (Na⁺), sulfate (SO²⁻₄), magnesium (Mg²⁺), calcium (Ca²⁺), and potassium (K+), in amounts which vary due, e.g., to addition or removal of water locally (e.g., through precipitation and evaporation).

When the metal is in Group 13 of the periodic table, the salt may be AlCl₃. The Group 13 metal chloride salt is present in an amount sufficient to provide the chloride ion in a concentration of >10 mM to <300 mM, alternatively 12 mM to 85 mM, and alternatively >12 mM to <85 mM based on the total amount of the composition, or an end-use composition comprising the same. Alternatively, the amount may be sufficient to provide >10 mM, alternatively at least 12 mM, alternatively at least 25 mM, alternatively at least 50 mM, alternatively at least 75 mM, alternatively at least 85 mM, and alternatively at least 100 mM; while at the same time the amount may be sufficient to provide <300 mM, alternatively up to 250 mM, alternatively up to 200 mM, alternatively up to 150 mM, alternatively up to 100 mM, and alternatively up to 85 mM, on the same basis above.

When the metal is in Group 2 of the periodic table, the salt may be a metal chloride salt selected from CaCl₂), MgCl₂, or a combination thereof. The Group 2 metal chloride salt is present in an amount sufficient to provide the chloride ion in a concentration >10 mM based on the total amount of the composition, or an end-use composition comprising the same. Without wishing to be bound by theory, the upper limit for the amount of the Group 2 metal chloride salt is not specifically restricted, however, a practical upper limit is the maximum amount of such salt that is soluble in the water in the foam stabilizing composition. Alternatively, the amount of the Group 2 metal chloride salt may be sufficient to provide a chloride ion concentration of >10 mM, alternatively at least 25 mM, alternatively at least 30 mM, alternatively at least 50 mM, alternatively at least 75 mM, and alternatively at least 100 mM, while at the same time the concentration may be up to the maximum solubility of the salt in water (e.g., maximum solubility of MgCl₂ is 5,600 mM and maximum solubility of CaCl₂ is 6,700 mM in water at 20° C.), alternatively up to 1010 mM, alternatively up to 1000 mM, alternatively up to 900 mM, alternatively up to 800 mM, alternatively up to 700 mM, and alternatively up to 600 mM. Alternatively, the amount of the Group 2 metal chloride salt may be sufficient to provide the chloride ion in a concentration of >10 mM to maximum solubility in water, alternatively >10 mM to 1010 mM, alternatively >10 mM to 600 mM, alternatively 100 mM to 1010 mM, and alternatively 100 to 600 mM.

Alternatively, when the metal is in Group 2, the metal sulfate salt may be selected from calcium sulfate, magnesium sulfate, or a combination thereof. Alternatively, the Group 2 metal sulfate salt may be calcium sulfate. The Group 2 metal sulfate salt may be present in an amount sufficient to provide the sulfate ion in a concentration≥10 mM based on the total amount of the composition, or an end-use composition comprising the same. Alternatively, the amount of Group 2 metal sulfate salt may be at least 10 mM, alternatively at least 15 mM, alternatively at least 20 mM, and alternatively at least 21 mM; while at the same time the concentration may be up to the maximum solubility of the Group 2 metal sulfate salt in water, alternatively up to 28 mM, alternatively up to 27 mM, alternatively up to 26 mM, alternatively up to 25 mM, alternatively up to 23 mM, and alternatively up to 21 mM, on the same basis above. Alternatively, the amount of the Group 2 metal sulfate salt may be sufficient to provide the sulfate ion in a concentration of ≥10 mM to maximum solubility in water, alternatively ≥10 mM to 28 mM, alternatively 15 mM to 28 mM, alternatively 20 mM to 25 mM, and alternatively 21 mM, on the same basis.

Alternatively, when the metal is in Group 1, the metal chloride salt may be NaCl, KCl, or a combination thereof. The Group 1 metal chloride salt is present in an amount sufficient to provide the chloride ion in a concentration >300 mM, based on the total amount of the composition, or an end-use composition comprising the same. Without wishing to be bound by theory, the upper limit for the amount of the Group 1 metal chloride salt is not specifically restricted, however, a practical upper limit is the maximum amount of such salt that is soluble in the water in the foam stabilizing composition. Alternatively, the amount of the Group 1 metal chloride salt may be sufficient to provide a chloride ion concentration of >300 mM, alternatively at least 325 mM, alternatively at least 395 mM, alternatively at least 350 mM, alternatively at least 400 mM, and alternatively at least 450 mM, alternatively at least 500 mM, alternatively at least 550 mM, and alternatively at least 575 mM; while at the same time the concentration may be up to a maximum solubility of the metal chloride salt in water (e.g., 6,100 mM for NaCl and 4,800 mM for KCl at 20° C.), alternatively up to 1010 mM, alternatively up to 1000 mM, alternatively up to 900 mM, alternatively up to 800 mM, alternatively up to 700 mM, and alternatively up to 600 mM. Alternatively, the amount of the Group 2 metal chloride salt may be sufficient to provide the chloride ion in a concentration of >300 mM, alternatively >300 mM to 1010 mM, alternatively 320 mM to 1010 mM, alternatively 450 to 1010 mM, and alternatively 395 mM to 600 mM.

Without wishing to be bound by theory, one skilled in the art would recognize that the concentrations recited above each refer to the concentration of the metal salt in a foam made with the composition; therefore, if other starting materials will be added to the composition described above to form the foam, the above concentrations may be adjusted in the compositions to provide amounts sufficient to provide the concentrations above in the foam. For example, the concentrations of salts may be raised, if treated water (e.g., deionized water) will be used to dilute the composition in the process for preparing the foam. Alternatively, the concentrations of salts may be the same or lowered, if a water source containing ions will be used for preparing the foam, e.g., when sea water will be added to the composition to prepare the foam.

### Starting Material b) Siloxane Cationic Surfactant

The foam stabilizing composition further comprises starting material b), the siloxane cationic surfactant. The siloxane cationic surfactant may comprise a water soluble/dispersible onium compound or amine containing compound with 1 or more siloxane chains (in linear, branched, hyperbranched, rake, pendant, terminal architectures).

The siloxane cationic surfactant may be a complex comprising a cationic organosilicon compound charge-balanced with a counter ion. The siloxane cationic surfactant b) may comprise a siloxane moiety and one or more quaternary ammonium moieties. The siloxane cationic surfactant may have general formula (I):

[Z¹-D¹−N(Y)ₐ(R)₂₋ₐ]^{+y}[X^{-x}]n (I),

where Z¹ is a siloxane moiety; D¹ is a divalent linking group; R is H or an unsubstituted hydrocarbyl group having from 1 to 4 carbon atoms; each Y has formula -D-NR¹₃⁺, where D is a divalent linking group and each R¹ is independently an unsubstituted hydrocarbyl group having from 1 to 4 carbon atoms; subscript a is 1 or 2; 1≤y≤3; X is an anion; subscript n is 1, 2, or 3; and 1≤x≤3, with the proviso that (x*n)=y.

In formula (I), Z¹ represents a siloxane moiety. In general, the siloxane moiety Z¹ comprises a siloxane and is otherwise not particularly limited. As understood in the art, siloxanes comprise an inorganic silicon-oxygen-silicon group (i.e., —Si—O—Si—), with organosilicon and/or organic side groups attached to the silicon atoms. As such, siloxanes may be represented by the general formula: ([R^{x}ᵢSiO_{(4-i)/}2]h)j(R^{x})₃₋ⱼSi−, where subscript i is independently selected from 1, 2, and 3 in each moiety indicated by subscript h, subscript h is at least 1, subscript j is 1, 2, or 3, and each R^{x} is independently selected from hydrocarbyl groups, alkoxy and/or aryloxy groups, and siloxy groups.

Hydrocarbyl groups suitable for R^{x} include monovalent hydrocarbon moieties, which may independently be substituted or unsubstituted, linear, branched, cyclic, or combinations thereof, and saturated or unsaturated. With regard to such hydrocarbyl groups, the term “unsubstituted” describes hydrocarbon moieties composed of carbon and hydrogen atoms, i.e., without heteroatom substituents. The term “substituted” describes hydrocarbon moieties where either at least one hydrogen atom is replaced with an atom or group other than hydrogen (e.g. an alkoxy group, or an amine group) (i.e., as a pendant or terminal substituent), a carbon atom within a chain/backbone of the hydrocarbon is replaced with an atom other than carbon (e.g. a heteroatom, such as oxygen, sulfur, or nitrogen) (i.e., as a part of the chain/backbone), or both. As such, suitable hydrocarbyl groups may comprise, or be, a hydrocarbon moiety having one or more substituents in and/or on (i.e., appended to and/or integral with) a carbon chain/backbone thereof, such that the hydrocarbon moiety may comprise, or be, e.g., an ether or an ester. Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be, e.g., aromatic or saturated and nonaromatic and/or non-conjugated. Examples of combinations of linear and cyclic hydrocarbyl groups include alkaryl groups and aralkyl groups. General examples of hydrocarbon moieties suitably for use in or as the hydrocarbyl group include alkyl groups, aryl groups, alkenyl groups, alkynyl groups, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, and other linear or branched saturated hydrocarbon groups, e.g. having greater than 6 carbon atoms. Examples of aryl groups include phenyl, tolyl, xylyl, naphthyl, benzyl, dimethyl phenyl, which may overlap with alkaryl groups (e.g. benzyl) and aralkyl groups (e.g. tolyl and dimethyl phenyl). Examples of alkenyl groups include vinyl, allyl, propenyl, isopropenyl, butenyl, isobutenyl, pentenyl, heptenyl, hexenyl, and cyclohexenyl groups.

Alkoxy and aryloxy groups suitable for R^{x} include those having the general formula —OR^{xi}, where R^{xi} is one of the hydrocarbyl groups set forth above with respect to R^{x}. Examples of alkoxy groups include methoxy, ethoxy, propoxy, butoxy, and benzyloxy. Examples of aryloxy groups include phenoxy, and tolyloxy.

Examples of suitable siloxy groups suitable for R^{x} include [M], [D], [T], and [Q] units, which, as understood in the art, each represent structural units of individual functionality present in siloxanes, such as organosiloxanes and organopolysiloxanes. More specifically, [M] represents a monofunctional unit of general formula R^{xii}₃SiO_{1/2}; [D] represents a difunctional unit of general formula R^{xii}₂SiO_{2/2}; [T] represents a trifunctional unit of general formula R^{xii}SiO_{3/2}; and [Q] represents a tetrafunctional unit of general formula SiO_{4/2}, as shown by the general structural moieties below:

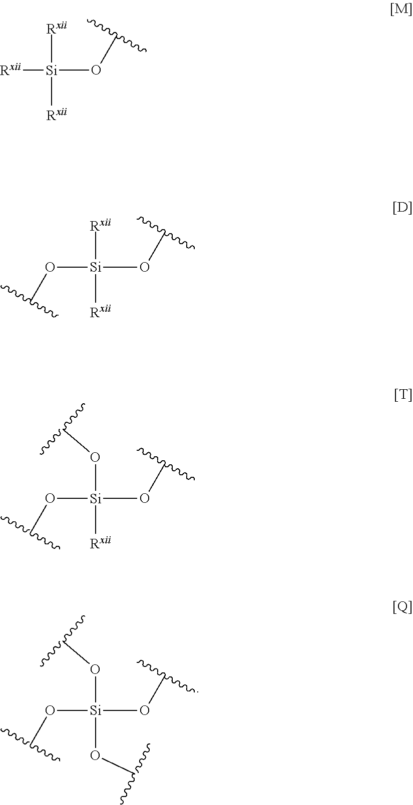

In these general structural moieties, each R^{Xii} is independently a monovalent or polyvalent substituent. As understood in the art, specific substituents suitable for each R^{Xii} are not limited, and may be monoatomic or polyatomic, organic or inorganic, linear or branched, substituted or unsubstituted, aromatic, aliphatic, saturated or unsaturated, and combinations thereof. Typically, each R^{xii} is independently selected from hydrocarbyl groups, alkoxy and/or aryloxy groups, and siloxy groups. As such, each R^{xii} may independently be a hydrocarbyl group of formula —R^{xi} or an alkoxy or aryloxy group of formula —OR^{xi}, where R^{xi} is as defined above, or a siloxy group represented by any one, or combination, of [M], [D], [T], and/or [Q] units described above.

The siloxane moiety Z¹ may be linear, branched, or combinations thereof, e.g. based on the number and arrangement of [M], [D], [T], and/or [Q] siloxy units present therein. When branched, the siloxane moiety Z¹ may minimally branched or, alternatively, may be hyperbranched and/or dendritic.

Alternatively, the siloxane moiety Z¹ may be a branched siloxane moiety having the formula —Si(R³)₃, where at least one R³ is —OSi(R⁴)₃ and each other R³ is independently selected from R² and —OSi(R⁴)₃, where each R⁴ is independently selected from R², —OSi(R⁵)₃, and —[OSiR²₂]ₘOSiR²₃. With regard to these selections for R⁴, each R⁵ is independently selected from R², —OSi(R⁶)₃, and —[OSiR²₂]ₘOSiR²₃, and each R⁶ is independently selected from R² and —[OSiR²₂]ₘOSiR²₃. In each selection, R² is an independently selected substituted or unsubstituted hydrocarbyl group, such as any of those described above with respect to R^{x}, and each subscript m is individually selected such that 0≤m≤100 (i.e., in each selection where applicable).

As introduced above, each R³ is selected from R² and —OSi(R⁴)₃, with the proviso that at least one R³ is of formula —OSi(R⁴)₃. Alternatively, at least two of R³ may be of formula —OSi(R⁴)₃. Alternatively, each R³ may be of formula —OSi(R⁴)₃. It will be appreciated that a greater number of R³ being —OSi(R⁴)₃ increases the level of branching in the siloxane moiety Z¹. For example, when each R³ is —OSi(R⁴)₃, the silicon atom to which each R³ is bonded is a T siloxy unit. Alternatively, when two of R³ are of formula OSi(R⁴)₃, the silicon atom to which each R³ is bonded is a [D] siloxy unit. Moreover, when R³ is of formula —OSi(R⁴)₃, and when R⁴ is of formula —OSi(R⁵)₃, further siloxane bonds and branching are present in the siloxane moiety Z¹. This is further the case when R⁵ is of formula —OSi(R⁶)₃. As such, it will be understood by those of skill in the art that each subsequent R³⁺ⁿ moiety in the siloxane moiety Z¹ can impart a further generation of branching, depending on the particular selections thereof. For example, R⁴ can be of formula —OSi(R⁵)₃, and R⁵ can be of formula —OSi(R⁶)₃. Thus, depending on a selection of each substituent, further branching attributable to [T] and/or [Q] siloxy units may be present in the siloxane moiety Z¹ (i.e., beyond those of other substituents/moieties described above).

Each R⁴ is selected from R², —OSi(R⁵)₃, and —[OSiR²₂]ₘOSiR²₃, where 0≤m≤100. Depending on a selection of R⁴ and R⁵, further branching can be present in the siloxane moiety Z¹. For example, when each R⁴ is R², then each —OSi(R⁴)₃ moiety (i.e., each R³ of formula —OSi(R⁴)₃) is a terminal [M] siloxy unit. Said differently, when each R³ is —OSi(R⁴)₃, and when each R⁴ is R², then each R³ can be written as —OSiR²₃ (i.e., an [M] siloxy unit). Alternatively, the siloxane moiety Z¹ may include a [T] siloxy unit bonded to group D in formula (I), which [T] siloxy unit is capped by three [M] siloxy units. Moreover, when of formula —[OSiR²₂]ₘOSiR²₃, R⁴ includes optional [D] siloxy units (i.e., those siloxy units in each moiety indicated by subscript m) as well as an [M] siloxy unit (i.e., represented by OSiR²₃). As such, when each R³ is of formula —OSi(R⁴)₃ and each R⁴ is of formula —[OSiR²₂]ₘOSiR²₃, then each R³ includes a [Q] siloxy unit. Alternatively, each R³ may be of formula —OSi([OSiR²₂]ₘOSiR²₃)₃, such that when each subscript m is 0, each R³ is a [Q] siloxy unit endcapped with three [M] siloxy units. Likewise, when subscript m is greater than 0, each R³ includes a linear moiety (i.e., a diorganosiloxane moiety) with a degree of polymerization being attributable to subscript m.

As set forth above, each R⁴ can also be of formula —OSi(R⁵)₃. Alternatively, when one or more R⁴ is of formula —OSi(R⁵)₃, further branching can be present in the siloxane moiety Z¹ depending a selection of R⁵. More specifically, each R⁵ may be selected from R², —OSi(R⁶)₃, and —[OSiR²₂]ₘOSiR²₃, where each R⁶ may be selected from R² and —[OSiR²₂]ₘOSiR²₃, and where each subscript m is defined above.

Subscript m is 0 to 100, alternatively 0 to 80, alternatively 0 to 60, alternatively 0 to 40, alternatively 0 to 20, alternatively 0 to 19, alternatively 0 to 18, alternatively 0 to 17, alternatively 0 to 16, alternatively 0 to 15, alternatively 0 to 14, alternatively 0 to 13, alternatively 0 to 12, alternatively 0 to 11, alternatively 0 to 10, alternatively 0 to 9, alternatively 0 to 8, alternatively 0 to 7, alternatively 0 to 6, alternatively 0 to 5, alternatively 0 to 4, alternatively 0 to 3, alternatively 0 to 2, alternatively 0 to 1, and alternatively m may be 0. Alternatively, each subscript m may be 0, such that the siloxane moiety Z¹ is free from [D] siloxy units.

Each of R², R³, R⁴, R⁵, and R⁶ are independently selected. As such, the descriptions above relating to each of these substituents is not meant to mean or imply that each substituent is the same. Rather, any description above relating to R⁴, for example, may relate to only one R⁴ or any number of R⁴ in the siloxane moiety Z¹, and so on. In addition, different selections of R², R³, R⁴, R⁵, and R⁶ can result in the same structures. For example, if R³ is —OSi(R⁴)₃, and if each R⁴ is —OSi(R⁵)₃, and if each R⁵ is R², then R³ can be written as —OSi(OSiR²₃)₃. Similarly, if R³ is —OSi(R⁴)₃, and if each R⁴ is —[OSiR²₂]ₘOSiR²₃, R³ can be written as —OSi(OSiR²₃)₃ when subscript m is 0. As shown, these particular selections result in the same final structure for R³, based on different selections for R⁴. Alternatively, R³, R⁴, R⁵, and R⁶ may be selected such that the siloxane cationic surfactant has an average of 3 to 10 silicon atoms per molecule; alternatively 3 to 6 silicon atoms per molecule. To that end, any proviso of limitation on final structure of the siloxane moiety Z¹ is to be considered met by an alternative selection that results in the same structure required in the proviso.

Alternatively, each R² may be an independently selected alkyl group. Alternatively, each R² may be an independently selected alkyl group having from 1 to 10, alternatively from 1 to 8, alternatively from 1 to 6, alternatively from 1 to 4, alternatively from 1 to 3, alternatively from 1 to 2 carbon atom(s). Alternatively, each R² may be methyl.

Alternatively, each subscript m may be 0 and each R² may be methyl, and the siloxane moiety Z¹ may have one of the following structures (i)-(iv):

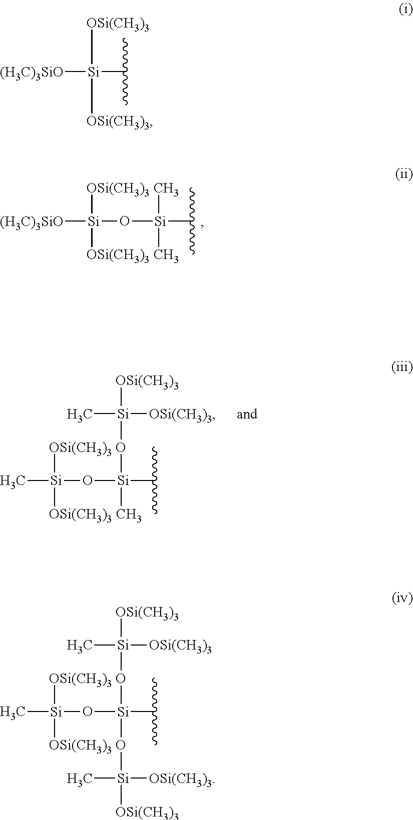

With further regard to the siloxane cationic surfactant and formula (I), as introduced above, D¹ is a divalent linking group. The divalent linking group D¹ is not particularly limited. Typically, divalent linking group D¹ is selected from divalent hydrocarbon groups. Examples of such hydrocarbon groups include divalent forms of the hydrocarbyl and hydrocarbon groups described above, such as any of those set forth above with respect to R^{x}. As such, it will be appreciated that suitable hydrocarbon groups for the divalent linking group D¹ may be substituted or unsubstituted, and linear, branched, and/or cyclic.

Alternatively, divalent linking group D¹ may comprise, alternatively divalent linking group D¹ is, a linear or branched alkyl and/or alkylene group. Alternatively, divalent linking group D¹ may comprise, alternatively divalent linking group D¹ is, a C₁-C₁₈ hydrocarbon moiety, such as a linear hydrocarbon moiety having the formula —(CH₂)_{d}—, where subscript d is from 1 to 18. Alternatively, subscript d may be 1 to 16, alternatively 1 to 12, alternatively 1 to 10, alternatively 1 to 8, alternatively 1 to 6, alternatively 2 to 6, alternatively 2 to 4. Alternatively, subscript d may be 3, such that divalent linking group D¹ comprises a propylene (i.e., a chain of 3 carbon atoms). As will be appreciated by those of skill in the art, each unit represented by subscript d is a methylene unit, such that linear hydrocarbon moiety may be defined or otherwise referred to as an alkylene group. It will also be appreciated that each methylene group may independently be unsubstituted and unbranched, or substituted (e.g. with a hydrogen atom replaced with a non-hydrogen atom or group) and/or branched (e.g. with a hydrogen atom replaced with an alkyl group). Alternatively, divalent linking group D¹ may comprise, alternatively divalent linking group D¹ is, an unsubstituted alkylene group. Alternatively, divalent linking group D¹ may comprise, alternatively divalent linking group D¹ is, a substituted hydrocarbon group, such as a substituted alkylene group. Alternatively, for example, divalent linking group D may comprise a carbon backbone having at least 2 carbon atoms and at least one heteroatom (e.g. O, N, S, or P), such that the backbone comprises an ether moiety, amine moiety, mercapto moiety, or phosphorous moiety.

Alternatively, divalent linking group D may comprise, alternatively divalent linking group D¹ is, an amino substituted hydrocarbon group (i.e., a hydrocarbon comprising a nitrogen-substituted carbon chain/backbone). For example, the divalent linking group D may be an amino substituted hydrocarbon having formula -D³-N(R⁷)-D³-, such that the siloxane cationic surfactant b) may be represented by the following formula: [Z¹-D³-N(R⁷)-D³-N(Y′)ₐ(R)₂₋ₐ]^{+y}[X^{-x}]ₙ, where each D³ is an independently selected divalent linking group, Z¹ is as defined and described above, R⁷ is Y′ or H, and each R, subscript a, X, superscript y, superscript x, and subscript n is as defined above and described below. Y′ is an independently selected group of formula -D-NR¹₃⁺, as described above for Y.

As introduced above, each D³ of the amino substituted hydrocarbon divalent linking group is independently selected. Typically, each D³ comprises an independently selected alkylene group, such as any of those described above with respect to divalent linking group D¹. For example, each D³ may be independently selected from alkylene groups having 1 to 8 carbon atoms, alternatively 2 to 8, alternatively 2 to 6, alternatively 2 to 4 carbon atoms. Alternatively, each D³ may be propylene (i.e., —(CH₂)₃—). However, it is to be appreciated that one or both D³ may be, or comprise, another divalent linking group (i.e., aside from the alkylene groups described above). Moreover, each D³ may be substituted or unsubstituted, linear or branched, and various combinations thereof.

As also introduced above, R⁷ of the amino substituted hydrocarbon is H or quaternary ammonium moiety Y′ (i.e., of formula -D-NR¹₃⁺, as set forth above). For example, R⁷ may be H, such that the siloxane cationic surfactant b) may be represented by the following formula: [Z¹-D³-NH-D³-N(Y′)ₐ(R)₂₋ₐ]^{+y}[X^{-x}]n, where each D³ and Z¹ is as defined and described above and each Y′, R, subscript a, X, superscript y, superscript x, and subscript n is as defined above and described below. Alternatively, superscript y may be 1 or 2, controlled by subscript a. More particularly, the number of quaternary ammonium moieties Y′ will be controlled by subscript a as 1 or 2, providing a total cationic charge of +1 or +2, respectively. Accordingly, superscript x may also be 1 or 2, such that the siloxane cationic surfactant b) will be charge balanced.

Alternatively, R⁷ of the amino substituted hydrocarbon may be the quaternary ammonium moiety Y′, such that the siloxane cationic surfactant b) may be represented by the following formula: [Z¹-D³-NY-D³-N(Y′)ₐ(R)₂₋ₐ]^{+y}[X^{-x}]ₙ, where each D³ and Z¹ is as defined and described above and each Y′, R, subscript a, X, superscript y, superscript x, and subscript n is as defined above and described below. Alternatively, y=a+1, such that superscript y is 2 or 3. More particularly, the number of quaternary ammonium moieties will include the Y′ of R⁷ as well as the 1 or 2 quaternary ammonium moiety Y′ controlled by subscript a, providing a total cationic charge of +2 or +3, respectively. Accordingly, superscript x may be 1, 2, or 3, such that the siloxane cationic surfactant b) will be charge balanced.

Alternatively, R⁷ may be Y′ and the siloxane moiety Z¹ may be the branched siloxane moiety described above, such that the siloxane cationic surfactant b) may be represented by the following formula: [(R³)₃Si-D³-N(−D-NR¹₃+)-D³-N(-D-NR¹₃+)ₐ(R)₂₋ₐ]^{+y}[X^{-x}]ₙ, where each D³ and R³ is as defined and described above, and each D, R, R¹, subscript a, X, superscript y, superscript x, and subscript n is as defined above and described below.

Subscript a is 1 or 2. As will be appreciated by those of skill in the art, subscript a indicates whether the quaternary ammonium-substituted amino moiety of the siloxane cationic surfactant b) represented by subformula —N(Y′)ₐ(R)₂−a has one or two of quaternary ammonium groups Y′ (i.e., the group of subformula (-D-NR¹₃+). Likewise, as each such quaternary ammonium groups Y′, subscript a also indicates the number of counter anions (i.e., number of anions X, as described below) required to balance out the cationic charge from the quaternary ammonium groups Y′ indicated by moieties a. For example, subscript a may be 1, and the siloxane cationic surfactant b) may have the following formula: [Z¹-D¹-N(R)-D-NR¹₃]^{+y}[X^{-x}]ₙ, where Z¹ and D¹ are as defined and described above, and each D, R, R¹, X, superscript y, superscript x, and subscript n is as defined above and described below.

It is to be appreciated that, while subscript a is 1 or 2 in each cationic molecule of the siloxane cationic surfactant b), the siloxane cationic surfactant b) may comprise a mixture of cationic molecules that correspond to formula (I) but are different from one another (e.g. with respect to subscript a). As such, while subscript a is 1 or 2, a mixture comprising the siloxane cationic surfactant b) may have an average value of a of from 1 to 2, such as an average value of 1.5 (e.g. from a 50:50 mixture of cationic molecules of the siloxane cationic surfactant b) where a=1 and molecules of the siloxane cationic surfactant b) where a=2.

Each R independently represents H or an unsubstituted hydrocarbyl group having from 1 to 4 carbon atoms, when present (e.g. when subscript a is 1). Alternatively, R may be H. Alternatively, R may be an alkyl group having from 1 to 4 carbon atoms, such as from 1 to 3, alternatively from 1 to 2 carbon atom(s). For example, R may be a methyl group, an ethyl group, a propyl group (e.g. an n-propyl or iso-propyl group), or a butyl group (e.g. an n-butyl, sec-butyl, iso-butyl, or tert-butyl group). Alternatively, each R may be methyl.

Each R¹ represents an independently selected unsubstituted hydrocarbyl group having from 1 to 4 carbon atoms. For example, each R¹ may be independently selected from alkyl groups having from 1 to 4 carbon atoms, such as from 1 to 3, alternatively from 1 to 2 carbon atom(s). Alternatively, each R¹ may be selected from methyl groups, ethyl groups, propyl groups (e.g. n-propyl and iso-propyl groups), and butyl group (e.g. n-butyl, sec-butyl, iso-butyl, and tert-butyl groups). While independently selected, each R¹ may be the same as each other R¹ in the cationic surfactant. For example, each R¹ may be methyl or ethyl. Alternatively, each R¹ may be methyl.

Each D represents an independently selected divalent linking group (“linking group D”). Typically, linking group D is selected from substituted and unsubstituted divalent hydrocarbon groups. Examples of such hydrocarbon groups include divalent forms of the hydrocarbyl and hydrocarbon groups described above, such as any of those set forth above with respect to R^{x}, D¹, and D³. As such, it will be appreciated that suitable hydrocarbon groups for use in or as linking group D may be linear or branched, and may be the same as or different from any other divalent linking group.

Alternatively, linking group D comprises an alkylene group, such as one of those described above with respect to divalent linking group D¹. For example, linking group D may comprise an alkylene group having from 1 to 8 carbon atoms, such as from 1 to 6, alternatively from 2 to 6, alternatively from 2 to 4 carbon atoms. Alternatively, the alkylene group of linking group D may be unsubstituted. Examples of such alkylene groups include methylene groups, ethylene groups, propylene groups, and butylene groups.

Alternatively, linking group D may comprise, alternatively divalent linking group D is, a substituted hydrocarbon group, such as a substituted alkylene group. For example, linking group D may comprise a carbon backbone having at least 2 carbon atoms, and at least one heteroatom (e.g. O) in the backbone or bonded to one of the carbon atoms thereof (e.g. as a pendant substituent). For example, linking group D may comprise a hydroxyl-substituted hydrocarbon having formula -D-CH(—(CH₂)ₑ—OH)-D′-, where each D′ is independently a covalent bond or a divalent linking group, and subscript e is 0 or 1. Alternatively, at least one D′ may comprise an independently selected alkylene group, such as any of those described above. For example, each D′ may be independently selected from alkylene groups having from 1 to 8 carbon atoms, such as from 1 to 6, alternatively from 1 to 4, alternatively from 1 to 2 carbon atoms. Alternatively, each D′ may be methylene (i.e., —CH₂—). However, it is to be appreciated that one or both D′ may be, or may comprise, another divalent linking group (i.e., aside from the alkylene groups described above).

Alternatively, each linking group D may be an independently selected hydroxy propylene group (i.e., where each D is an independently selected from the covalent bond and methylene, with the provisos that at least one D′ is the covalent bond when subscript e is 1, and each D is methylene when subscript e is 0). Accordingly, each linking group D may be independently of one of the following formulas:

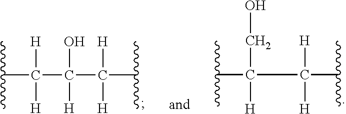 [SMILES: *CC(O)C* ; *CC(*)CO]

Alternatively, siloxane moiety Z¹ may be the branched siloxane moiety, divalent linking group D may be the amino substituted hydrocarbon where each D³ is propylene and R⁷ is H, subscript a is 1, R is H, each linking group D is a (2-hydroxy)propylene group, each R¹ is methyl, and X is a monoanion, such that the siloxane cationic surfactant b) of formula (I) has the following formula:

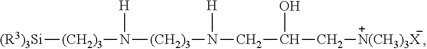

where each R³ is as defined and described above, and X is as defined above and described below. Alternatively, the siloxane cationic surfactant b) may be configured the same as described immediately above, but with subscript a=2, such that the siloxane cationic surfactant b) of formula (I) has the following formula:

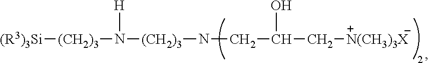

where each R³ is as defined and described above, and each X is as defined above and described below. Alternatively, the siloxane cationic surfactant b) may be configured the same as described immediately above, but with R⁷ being the quaternary ammonium moiety Y′, such that the siloxane cationic surfactant b) of formula (I) has the following formula:

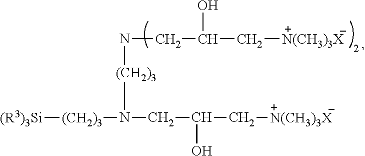

where each R³ is as defined and described above, and each X is as defined above and described below. Alternatively, the siloxane cationic surfactant b) may be configured the same as described immediately above, but with subscript a=1 and R being H, such that the siloxane cationic surfactant b) of formula (I) has the following formula:

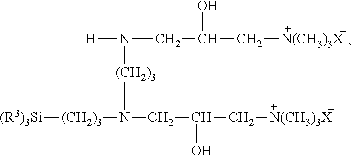

where each R³ is as defined and described above, and each X is as defined above and described below.

Each X is an anion having a charge represented by superscript x. Accordingly, as will be understood by those of skill in the art, X is not particularly limited and may be any anion suitable for ion-pairing/charge-balancing one or more cationic quaternary ammonium moieties Y and Y′. As such, each X may be an independently selected monoanion or polyanion (e.g. dianion or trianion), such that one X may be sufficient to counterbalance two or more cationic quaternary ammonium moieties Y′. As such, the number of anions X (i.e., subscript n) will be readily selected based on the number of cationic quaternary ammonium moieties Y′ and the charge of X selected (i.e., superscript x).

Examples of suitable anions include organic anions, inorganic anions, and combinations thereof. Typically, each anion X is independently selected from monoanions that are unreactive the other moieties of the cationic surfactant. Examples of such anions include conjugate bases of medium and strong acids, such as halide ions (e.g. chloride, bromide, iodide, fluoride), sulfates (e.g. alkyl sulfates), sulfonates (e.g. benzyl or other aryl sulfonates) as well as combinations thereof. Other anions may also be utilized, such as phosphates, nitrates, organic anions such as carboxylates (e.g. acetates) as well as combinations thereof. It is to be appreciated that derivatives of such anions include polyanionic compounds comprising two or more functional groups for which the above examples are named. For example, mono and/or polyanions of polycarboxylates (e.g. citric acid) are encompassed by the anions above. Other examples of anions include tosylate anions.

Alternatively, each anion X may be an inorganic anion having one to three valences. Examples of such anions include monoanions such as chlorine, bromine, iodine, aryl sulfonates having six to 18 carbon atoms, nitrates, nitrites, and borate anions, dianions such as sulfate and sulfite, and trianions such as phosphate. Alternatively, each X may be a halide anion, alternatively each X may be chloride (i.e., Cl⁻) or iodide (i.e., I—); alternatively each X may be chloride.

Siloxane cationic surfactants may be prepared by the method described in U.S. Provisional Patent Application Ser. No. 62/955,192 filed on 30 Dec. 2019, which is hereby incorporated by reference, by varying appropriate starting materials, as exemplified below in in the Reference Examples for preparing siloxane cationic surfactants.

The amount of the siloxane cationic surfactant b) used in the foam stabilizing composition depends on various factors including the form of the composition prepared, a desired use thereof, and other starting materials present therein. For example, one of skill in the art will appreciate that, when the composition is formulated as a concentrate, the siloxane cationic surfactant b) will be present in higher relative amounts as compared to non-concentrated forms. As such, the siloxane cationic surfactant b) may be present in the foam stabilizing composition in an amount sufficient to provide a weight ratio of salt:siloxane cationic surfactant i.e., a):b) weight ratio of 0.05:1 to 500:1, alternatively 0.1:1 to 50:1, when starting material c), the organic cationic surfactant, is not present. Alternatively, when starting material c) is present, then the amounts of salt:cationic surfactants, i.e., weight ratio of starting material a): starting materials b) and c), i.e. a:(b+c) is of 0.05:1 to 500:1, alternatively 0.1:1 to 50:1.

### c) Organic Cationic Surfactant

As introduced above, starting material c) is an optional organic cationic surfactant, i.e., a complex comprising a cationic quaternary organoammonium compound charge-balanced with a counter ion. The organic cationic surfactant c) comprises a hydrocarbon moiety and one or more quaternary ammonium moieties, and conforms to general formula (II): [Z²-D²-N(Y′)_{b}(R)_{2-b}]y [X^{-x}]ₙ, where Z² is an unsubstituted hydrocarbyl group; D² is a covalent bond or a divalent linking group; subscript b is 1 or 2; and each R, Y, superscript y, X, subscript n, and superscript x is independently selected and as defined above.

With regard to the organic cationic surfactant c) and formula (II), each R, Y′, superscript y, X, subscript n, and superscript x is independently selected and as defined above with respect to the siloxane cationic surfactant b). As such, while specific selections are exemplified below with regard to these variables in formula (II) representing the organic cationic surfactant c), it will be appreciated that such selections are not limiting, but rather that all description of R, Y′, superscript y, X, subscript n, and superscript x, as well as variables thereof (e.g. divalent linking group D of quaternary ammonium moieties Y′, groups D and subscripts e of divalent linking groups D).

In formula (II), Z² is an unsubstituted hydrocarbyl group, and is otherwise not particularly limited. Examples of suitable such hydrocarbyl group include the unsubstituted monovalent hydrocarbon moieties described above with respect to R^{x}. As such, it will be appreciated that the hydrocarbyl group Z² may comprise, alternatively may be, linear, branched, cyclic, or combinations thereof. Likewise, the hydrocarbyl group Z² may comprise aliphatic unsaturation, including ethylenic and/or acetylenic unsaturation (i.e., C—C double and/or triple bonds, otherwise known as alkenes and alkynes, respectively). The hydrocarbyl group Z² may comprise but one such unsaturated group or, alternatively, may comprise more than one unsaturated group, which may be nonconjugated, or conjugated (e.g. when the hydrocarbyl group Z² comprises, e.g. a diene, an ene-yne, or a diyne) and/or aromatic (e.g. when the hydrocarbyl group Z² comprises, e.g., a phenyl group or a benzyl group).

Alternatively, the hydrocarbyl group Z² may be an unsubstituted hydrocarbyl moiety having from 3 to 18 carbon atoms. Alternatively, the hydrocarbyl group Z² may comprise, alternatively the hydrocarbyl group Z² may be, an alkyl group. Suitable alkyl groups include saturated alkyl groups, which may be linear, branched, cyclic (e.g. monocyclic or polycyclic), or combinations thereof. Examples of such alkyl groups include those having the general formula C_{f}H_{2f-2g+1}, where subscript f is from 5 to 20 (i.e., the number of carbon atoms present in the alkyl group), subscript g is the number of independent rings/cyclic loops, and at least one carbon atom designated by subscript f is bonded to group D² in general formula (II) above. Examples of linear and branched isomers of such alkyl groups (i.e., where the alkyl group is free from cyclic groups such that subscript f=0), include those having the general formula C_{f}H_{2f+1}, where subscript f is as defined above and at least one carbon atom designated by subscript f is bonded to group D² in general formula (II) above. Examples of monocyclic alkyl groups include those having the general formula C_{f}H_{2f-1}, where subscript f is as defined above and at least one carbon atom designated by subscript f is bonded to group D² in general formula (II) above.

Specific examples of such alkyl groups include pentyl groups, hexyl groups, heptyl groups, octyl groups, nonyl groups, decyl groups, undecyl groups dodecyl groups, tridecyl groups, tetradecyl groups, pentadecyl groups, hexadecyl groups, heptadecyl groups, octadecyl groups, nonadecyl groups, and eicosyl groups, including linear, branched, and/or cyclic isomers thereof. For example, pentyl groups encompass n-pentyl (i.e., a linear isomer) and cyclopentyl (i.e., a cyclic isomer), as well as branched isomers such as isopentyl (i.e., 3-methylbutyl), neopentyl (i.e., 2,2-dimethylpropyl), tert-pentyl (i.e., 2-methylbutan-2-yl), sec-pentyl (i.e., pentan-2-yl), sec-isopentyl (i.e., 3-methylbutan-2-yl)), 3-pentyl (i.e., pentan-3-yl), and active pentyl (i.e., 2-methylbutyl).

Alternatively, the hydrocarbyl group Z² may comprise, alternatively may be, an unsubstituted linear alkyl group of formula —(CH₂)_{f-1}CH₃, where subscript f is 5 to 20 as described above. Alternatively, the hydrocarbyl group Z² may be such an unsubstituted linear alkyl group, where subscript f is 7 to 19, such that the hydrocarbyl group Z² is an unsubstituted linear alkyl group having from 6 to 18 carbon atoms. Alternatively, subscript b may be 7, 9, 11, or 13, such that the hydrocarbyl group Z² may be an unsubstituted linear alkyl group having 6, 8, 10, or 12 carbon atoms, respectively.

Subscript b is 1 or 2. As will be appreciated by those of skill in the art in view of the description relating to subscript a of the siloxane cationic surfactant b), subscript b indicates whether the quaternary ammonium-substituted amino moiety of the organic cationic surfactant c) represented by subformula —N(Y′)_{b}(R)_{2-b} has one or two of quaternary ammonium groups Y′ (i.e., the group of subformula (-D-NR¹₃+). Likewise, as each such quaternary ammonium groups Y′, subscript b also indicates the number of counter anions (i.e., number of anions X, as described below) required to balance out the cationic charge from the quaternary ammonium groups Y′ indicated by moieties b.

It is to be appreciated that, while subscript b is 1 or 2 in each cationic molecule of the organic cationic surfactant c), the organic cationic surfactant c) may comprise a mixture of cationic molecules that correspond to formula (II) but are different from one another (e.g. with respect to subscript b). As such, while subscript b is 1 or 2, a mixture comprising the organic cationic surfactant c) may have an average value of b of from 1 to 2, such as an average value of 1.5 (e.g. from a 50:50 mixture of cationic molecules of the organic cationic surfactant c) where b=1 and molecules of the organic cationic surfactant c) where b=2.

With further regard to the organic cationic surfactant c) and formula (II), as introduced above, D² represents a covalent bond or a divalent linking group. For clarity and ease of reference, D² may be referred to more particularly as the “covalent bond D²” or “divalent linking group D²”, e.g. when D² is the covalent bond or the divalent linking group, respectively. Both selections are described and illustrated below.

Alternatively, D² may be the covalent bond (i.e., the organic cationic surfactant c) comprises the covalent bond D²), such that hydrocarbyl moiety Z² is bonded directly to the amino N atom, and the organic cationic surfactant c) may be represented by the following formula: [Z²—N(Y′)_{b}(R)_{2-b}]^{+y}[X^{x-x}]ₙ, where each Z², Y′, R, X, subscript b, superscript y, superscript x, and subscript n are as defined and described above. Alternatively, the hydrocarbyl moiety Z² may be an alkyl group bonded directly to the amino N atom of the organic cationic surfactant c), such that the organic cationic surfactant c) has the following formula: [(C_{f}H₂f+1)-N(Y′)_{b}(R)_{2-b}]^{+y}[X^{-x}]ₙ, where subscript b, subscript f, Y′, R, X, superscript y, superscript x, and subscript n are as defined and described above. Alternatively, subscript f may be 6 to 18, such as 6 to 14, alternatively from 6 to 12.

Alternatively, D² may be the divalent linking group bond (i.e., the organic cationic surfactant c) comprises the divalent linking group D²). The divalent linking group D² is not particularly limited, and is generally selected from the same groups described above with respect to divalent linking group D¹. Accordingly, divalent linking group D² may be selected from divalent hydrocarbon groups. Examples of such hydrocarbon groups include divalent forms of the hydrocarbyl and hydrocarbon groups described above, such as any of those set forth above with respect to R^{x}. As such, it will be appreciated that suitable hydrocarbon groups for the divalent linking group D² may be substituted or unsubstituted, linear, branched, and/or cyclic, and the same or different from any other linking group in the organic cationic surfactant c) and/or the siloxane cationic surfactant b).

Alternatively, divalent linking group D² may comprise, alternatively may be a linear or branched alkyl and/or alkylene group. Alternatively, divalent linking group D² may comprise, alternatively may be, a C₁-C₁₈ hydrocarbon moiety, such as the linear hydrocarbon moiety having the formula —(CH₂)_{d}—, defined above with respect to D¹ (i.e., where subscript d is 1 to 18). Alternatively, subscript d may be 1 to 16, alternatively 1 to 12, alternatively 1 to 10, alternatively 1 to 8, alternatively 1 to 6, alternatively 2 to 6, alternatively 2 to 4. Alternatively, subscript d may be 3, such that divalent linking group D² comprises a propylene (i.e., a chain of 3 carbon atoms). It will also be appreciated that each alkyl and/or alkylene group suitable for D² may independently be unsubstituted and unbranched, or substituted and/or branched. Alternatively, divalent linking group D² may comprise, alternatively may be, an unsubstituted alkylene group. Alternatively, divalent linking group D² may comprise, alternatively may be, a substituted hydrocarbon group, such as a substituted alkylene group. For example, divalent linking group D² may comprise a carbon backbone having at least 2 carbon atoms and at least one heteroatom (e.g. O, N, S, or P), such that the backbone comprises, e.g., an ether moiety or amine moiety.

Alternatively, divalent linking group D² may comprise, alternatively may be, an amino substituted hydrocarbon group (i.e., a hydrocarbon comprising a nitrogen-substituted carbon chain/backbone). For example, the divalent linking group D² may be an amino substituted hydrocarbon having formula -D⁴-N(R⁸)-D⁴-, such that the organic cationic surfactant c) may be represented by the following formula: [Z²-D⁴-N(R⁸)-D⁴-N(Y′)_{b}(R)_{2-b}]^{+y}[X^{-x}]ₙ, where each D⁴ is an independently selected divalent linking group, R⁸ is Y′ or H, and each Z², Y′, R, subscript b, X, superscript y, superscript x, and subscript n is as defined and described above.

As introduced above, each D⁴ of the amino substituted hydrocarbon divalent linking group is independently selected. Typically, each D⁴ comprises an independently selected alkylene group, such as any of those described above with respect to divalent linking group D³ of the siloxane cationic surfactant b). For example, each D⁴ may be independently selected from alkylene groups having from 1 to 8 carbon atoms, such as from 2 to 8, alternatively from 2 to 6, alternatively from 2 to 4 carbon atoms. Alternatively, each D⁴ may be propylene (i.e., —(CH₂)₃—). However, it is to be appreciated that one or both D⁴ may be, or comprise, another divalent linking group (i.e., aside from the alkylene groups described above). Moreover, each D⁴ may be substituted or unsubstituted, linear or branched, and various combinations thereof.

As also introduced above, R⁸ of the amino substituted hydrocarbon is H or quaternary ammonium moiety Y′ (i.e., of formula -D-NR¹₃⁺, as set forth above). For example, R⁸ may be H, such that the organic cationic surfactant c) may be represented by the following formula: [Z²-D⁴-NH-D⁴-N(Y′)_{b}(R)_{2-b}]^{+y}[X^{-x}]ₙ, where each Z², D⁴, Y′, R, subscript b, X, superscript y, superscript x, and subscript n is as defined and described above. Alternatively, superscript y may be 1 or 2, controlled by subscript b. More particularly, the number of quaternary ammonium moieties Y′ will be controlled by subscript b as 1 or 2, providing a total cationic charge of +1 or +2, respectively. Accordingly, superscript x will also be 1 or 2, such that the organic cationic surfactant c) will be charge balanced.

Alternatively, R⁸ may be Y′, such that the organic cationic surfactant c) may be represented by the following formula: [Z²-D⁴-NY-D⁴-N(Y′)_{b}(R)_{2-b}]^{+y}[X^{-x}]ₙ, where each Z², D⁴, Y, Y′, R, subscript b, X, superscript y, superscript x, and subscript n is as defined and described above. Alternatively, y=b+1, such that superscript y is 2 or 3. More particularly, the number of quaternary ammonium moieties will include the Y′ of R⁸ as well as the 1 or 2 quaternary ammonium moiety Y′ controlled by subscript b, providing a total cationic charge of +2 or +3, respectively. Accordingly, superscript x will be 1, 2, or 3, such that the organic cationic surfactant c) will be charge balanced. For example, subscript b may be 1 and X may be monoanionic, such that the organic cationic surfactant c) has the following formula:

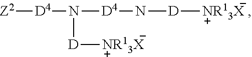

where each Z², D⁴, R, D, R¹, and X is as defined and described above. Alternatively, the organic cationic surfactant c) may be configured as described immediately above, but with b=2, such that the organic cationic surfactant c) has the following formula:

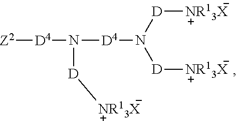

where each Z², D⁴, D, R¹, and X is as defined and described above.

Alternatively, D² may be the covalent bond, Z² may be the linear alkyl group, subscript b may be 1, R may be H, each linking group D may be a (2-hydroxy)propylene group, each R¹ may be methyl, and X may be a monoanion, such that the organic cationic surfactant c) has the following formula:

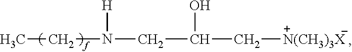

where subscript f is 5 to 17 (e.g. alternatively 5 to 11, alternatively 5 to 9), and X is as defined and described above. Alternatively, the organic cationic surfactant c) may be configured the same as described immediately above, but with subscript b=2, such that the organic cationic surfactant c) has the following formula:

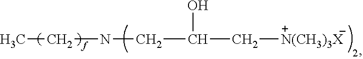

where each X is as defined above and described below.

Alternatively, Z² may be a linear alkyl group having from 3 to 13 carbon atoms, the divalent linking group D² may be the amino substituted hydrocarbon where each D⁴ may be propylene and R⁸ may be H, subscript b may be 1, R may be H, each linking group D may be a (2-hydroxy)propylene group, each R¹ may be methyl, and X may be a monoanion, such that the organic cationic surfactant c) has the following formula:

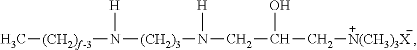

where subscript f and X are as defined and described above. Alternatively, the organic cationic surfactant c) may be configured the same as described immediately above, but with subscript b=2, such that the organic cationic surfactant c) has the following formula:

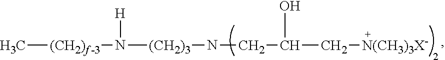

where subscript f and each X are as defined and described above. Alternatively, the organic cationic surfactant c) may be configured the same as described immediately above, but with R⁸ being the quaternary ammonium moiety Y′, such that the organic cationic surfactant c) has the following formula:

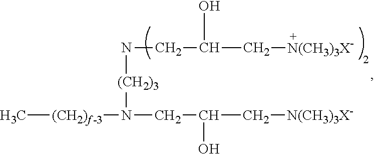

where subscript f and each X are as defined and described above. Alternatively, the organic cationic surfactant c) may be configured the same as described immediately above, but with subscript b=1 and R being H, such that the organic cationic surfactant c) has the following formula:

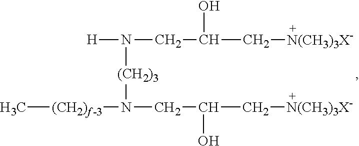

where subscript f and each X are as defined and described above.

Alternatively, each anion X of the organic cationic surfactant c) is an inorganic anion having one to three valences. Examples of such anions include monoanions such as chlorine, bromine, iodine, aryl sulfonates having six to 18 carbon atoms, nitrates, nitrites, and borate anions, dianions such as sulfate and sulfite, and trianions such as phosphate. Alternatively, each X may be a halide anion. Alternatively, each X may chloride (i.e., Cl⁻).

and an organic cationic surfactant c) having one of the following formulas (c-i)-(c-iii):

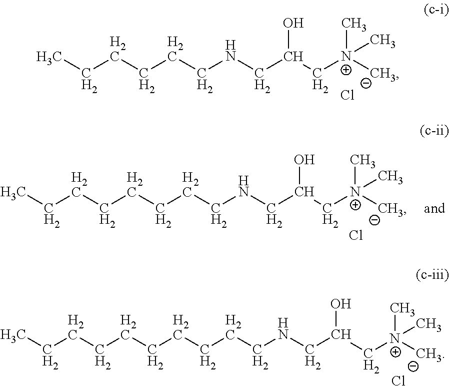

The organic cationic surfactant c) may comprise a combination or two or more different organic cationic surfactants represented by general formula (II) above that differ in at least one property such as structure, molecular weight, degree of branching, and number of cationic quaternary ammonium groups Y′ (e.g. when subscript b represents an average value). Organic cationic surfactants may be prepared by the method described in U.S. Provisional Patent Application Ser. No. 62/955,192 filed on 30 Dec. 2019, which is hereby incorporated by reference.

The organic cationic surfactant c) is optional and may be utilized in any amount in the foam stabilizing composition, depending on various factors including the form of the composition prepared, a desired use thereof, and other starting materials present therein. For example, one of skill in the art will appreciate that, when the foam stabilizing composition is formulated as a concentrate, the organic cationic surfactant c) will be present in higher relative amounts as compared to non-concentrated forms (e.g. aqueous film-forming foam compositions). As such, the organic cationic surfactant c) may be present in the composition in any amount, such as an amount of from 0.001% to 60%, based on the total weight of the composition. When the organic cationic surfactant c) is present, the composition may comprise the organic cationic surfactant c) in an amount sufficient to provide an end-use composition (i.e., any fully formulated composition comprising the foam stabilizing composition ready for a use) with 0.01% to 2% of the organic cationic surfactant c), based on the total weight of the end-use composition (i.e., an active amount of organic cationic surfactant c) of 0.01% to 2%, alternatively 0.1% to 1.5%, alternatively 0.5% to 1%). For example, the organic cationic surfactant c) may be utilized in an active amount of 0.05% to 2%, alternatively 0.1% to 1%, alternatively 0.1% to 0.9%, alternatively 0.1% to 0.7%, alternatively 0.2% to 0.7%, alternatively 0.2% to 0.5%, based on the total weight of the composition, or an end-use composition comprising the same. Alternatively, the organic cationic surfactant c) may be used in an amount sufficient to provide a weight ratio of organic cationic surfactant:salt (c:a) of 1:0.05 to 1:100 in the composition.

It is to be appreciated that each of the siloxane cationic surfactant b) and, when present, the organic cationic surfactant c) is independently selected, and thus each variable in formulas (I), and (II), even where representing the same group/moiety and/or having the same definition, is independently selected. However, the siloxane cationic surfactant b) and the organic cationic surfactant c) may be configured in a similar manner with respect to one or more variables in in formulas (I) and (II). For example, each R¹ of the siloxane cationic surfactant b) and the organic cationic surfactant c) may be methyl. Alternatively, each D of the siloxane cationic surfactant b) and the organic cationic surfactant c) may be independently a hydroxypropylene group of one of the following formulas:

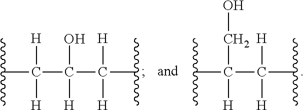 [SMILES: *CC(O)C* ; *CC(*)CO]

Alternatively, each anion X of the siloxane cationic surfactant b) and the organic cationic surfactant c) may be the same. For example, each X of the siloxane cationic surfactant b) and the organic cationic surfactant c) may be a halide anion, alternatively chloride (Cl⁻).

The relative amounts of the siloxane cationic surfactant b) and, when present, the organic cationic surfactant c) utilized in the composition vary, e.g. depending on various factors including the particular siloxane cationic surfactant b) selected, the particular organic cationic surfactant c) selected, and whether another starting material is utilized in the composition. When the organic cationic surfactant c) is present, the siloxane cationic surfactant b) and the organic cationic surfactant c) may be utilized in a ratio of 10:1 to 1:10, such as 8:1 to 1:8, alternatively 6:1 to 1:6, alternatively 4:1 to 1:4, alternatively 2:1 to 1:2, alternatively 1:1 b):c). For example, the composition may comprise an excess of the organic cationic surfactant c) in relation to the siloxane cationic surfactant b), such that the siloxane cationic surfactant b) and the organic cationic surfactant c) are utilized in a weight ratio of less than 1:1 b):c), such as 1:1.1 to 1:10, alternatively 1:1.5 to 1:10, alternatively 1:2 to 1:10, alternatively 1:3 to 1:10, alternatively 1:4 to 1:10, alternatively 1:5 to 1:10 b):c).

Alternatively, the composition may comprise an excess of siloxane cationic surfactant b) in relation to the organic cationic surfactant c), such that the siloxane cationic surfactant b) and the organic cationic surfactant c) are utilized in a weight ratio of greater than 1:1 b):c), such as 1.1:1 to 10:1, alternatively 1.5:1 to 10:1, alternatively 2:1 to 10:1, alternatively 2:1 to 8:1, alternatively 2:1 to 6:1, alternatively 2:1 to 5:1 b):c). It will be appreciated, however, that ratios outside of the specific ranges above may also be utilized. For example, one of the siloxane cationic surfactant b) and organic cationic surfactant c) may be utilized in a gross excess of the other (e.g. in an amount of ≥5, alternatively ≥10, alternatively ≥15, alternatively ≥20, times amount of the other).

### Additional Starting Materials

The foam stabilizing composition may optionally further comprise a carrier vehicle (e.g. a solvent, diluent, or dispersant). When used, the carrier vehicle will be selected depending on various factors such as the species of siloxane cationic surfactant b) and the organic cationic surfactant c), if present, any other starting materials in the composition, and the desired end use of the composition.

Examples of solvents include aqueous solvents, water miscible organic solvents, and combinations thereof. Examples of aqueous solvents include water and polar and/or charged (i.e., ionic) solvents miscible with water. Examples of organic solvents include those comprising an alcohol, such as methanol, ethanol, isopropanol, 1-propanol, 2-propanol, butanol, 2-methyl-2-propanol, and n-propanol; a glycol such as ethylene glycol, propylene glycol, a glycol ether, such as propylene glycol methyl ether, dipropylene glycol methyl ether, propylene glycol n-butyl ether, propylene glycol n-propyl ether, and ethylene glycol n-butyl ether.

Alternatively, the composition may comprise (d-1) a solvent. The solvent (d-1) may facilitate introduction of certain starting materials into the composition, mixing and/or homogenization of the starting materials. Likewise, the particular solvent (d-1) will be selected based on the solubility of starting material b) and/or other starting materials utilized in the composition, the volatility (i.e., vapor pressure) of the solvent, and the end-use of the composition. The solvent may comprise water. The solvent (d-1) should be sufficient to dissolve the salt silica a), and dissolve or disperse the siloxane cationic surfactant b), and any additional starting materials to form a homogenous composition. As such, solvents for use in the composition may generally be selected from any of the carrier vehicles described above suitable for fluidizing and/or dissolving starting materials a) and b), and/or another starting material of the composition. As will be understood by those of skill in the art, while organic solvents may be utilized in the composition, such organic solvents will typically be removed before utilizing the composition, or an end-use composition comprising the same, especially if the organic solvents are flammable.

Alternatively, the solvent (d-1) may be an aqueous solvent, and comprises, alternatively consists essentially of, or alternatively is, water. The water is not particularly limited. For example, purified water such as distilled water and ion exchanged water, saline, a phosphoric acid buffer aqueous solution, or a water containing a base sufficient to render the pH of the water of 7 to 10, alternatively 9 to 10, or combinations thereof, can be used. Alternatively, the solvent (d-1) may comprise water and at least one other solvent (i.e., a co-solvent), such as a water-miscible solvent. Examples of such co-solvents may include any of the water miscible carrier vehicles described above. Particular examples of co-solvents include glycerol, sorbitol, ethylene glycol, propylene glycol, hexylene glycol, polyethylene glycol (PEG), ethers of diethylene and dipropylene glycols (e.g. methyl, ethyl, propyl, and butyl ethers), and combinations thereof.

The amount of solvent (d-1) utilized is not limited, and depend on various factors, including the type of solvent selected, the amount and type of salt a), siloxane cationic surfactant b) employed, and the form of the composition (i.e., whether a concentrate, intermediate, or end-use composition). Typically, the amount of solvent d-1) utilized may range from 0.1% to 99.9%, based on the total weight of the composition, or the total combined weights of salt a) and siloxane cationic surfactant b), and solvent d-1), and when present, organic cationic surfactant c). Alternatively, the solvent may comprise water, and the composition may comprise a weight ratio of water to salt (d:a) of 1:10⁻⁴ to 1:3. Alternatively, the solvent (d-1) may be utilized in an amount of from 50% to 99.9%, such as 60% to 99.9%, alternatively 70% to 99.9%, alternatively 80% to 99.9%, alternatively 90% to 99.9%, alternatively 95% to 99.9%, alternatively 98% to 99.9%, alternatively 98.5% to 99.9%, alternatively 98.5% to 99.7%, alternatively 98.7% to 99.7%, based on the combined weights of starting materials a), b), and (d-1), and when present c). One of skill in the art that the upper limits of these ranges generally reflect the active amounts of salt a) and siloxane cationic surfactant b) utilized (i.e., in an end-use composition). As such, amounts outside these ranges may also be utilized.

In the composition, the salt a), the siloxane cationic surfactant b), and water may be used alone or in combination with at least one additional starting material (such as the organic cationic surfactant c) described above or other additional starting material, described hereinbelow). As such, the composition may further comprise one or more additional starting materials. It is to be appreciated that such starting materials may be classified under different terms of art and just because a starting material is classified under such a term does not mean that it is thusly limited to that function. Moreover, some of these starting materials may be present in a particular component of the composition, or instead may be incorporated when forming the composition. Typically, the composition may comprise any number of starting materials, e.g. depending on the particular type and/or function of the same in the composition.

For example, the composition may comprise one or more starting materials comprising, alternatively consisting essentially of, alternatively consisting of: e) an additional surfactant which differs from the siloxane cationic surfactant b) and the organic cationic surfactant c), described above; f) a rheology modifier; g) a pH control agent; and h) a foam enhancer.

The composition may optionally further comprise the additional surfactant e). The additional surfactant e) is a surfactant other than the cationic surfactants b), and when present c). The additional surfactant e) is not anionic. As such, the additional surfactant e) may comprise one or more cationic, nonionic, and/or amphoteric surfactants, such as any one or more of those described below. In general, the additional surfactant e) is selected to impart, alter, and/or facilitate certain properties of the composition and/or an end-use composition comprising the same, such as compatibility, foamability, foam stability, foam spreading and/or drainage (e.g. vapor sealing/containment). Alternatively, the surfactant e) may be selected from water soluble surfactants.

Alternatively, the additional surfactant e) may comprise, alternatively may be an additional cationic surfactant other than the cationic surfactants b) and c) described above. Examples of such cationic surfactants include various fatty acid amines and amides, and the salts of the fatty acid amines and amides. Examples of aliphatic fatty acid amines include dodecylamine acetate, octadecylamine acetate, and acetates of the amines of tallow fatty acids, homologues of aromatic amines having fatty acids such as dodecylanalin, fatty amides derived from aliphatic diamines such as undecylimidazoline, fatty amides derived from aliphatic diamines such as undecylimidazoline, fatty amides derived from disubstituted amines such as oleylaminodiethylamine, derivatives of ethylene diamine, quaternary ammonium compounds and their salts which are exemplified by tallow trimethyl ammonium chloride, dioctadecyldimethyl ammonium chloride, didodecyldimethyl ammonium chloride, dihexadecyl ammonium chloride, alkyltrimethylammonium hydroxides such as octyltrimethylammonium hydroxide, dodecyltrimethylammonium hydroxide, and hexadecyltrimethylammonium hydroxide, dialkyldimethylammonium hydroxides such as octyldimethylammonium hydroxide, decyldimethylammonium hydroxide, didodecyldimethylammonium hydroxide, dioctadecyldimethylammonium hydroxide, tallow trimethylammonium hydroxide, coconut oil, trimethylammonium hydroxide, methylpolyoxyethylene cocoammonium chloride, and dipalmitylhydroxyethylammonium methosulfate, amide derivatives of amino alcohols such as beta-hydroxylethylstearylamide, amine salts of long chain fatty acids, and combinations thereof.

Alternatively, the surfactant e) may comprise, alternatively may be, a nonionic surfactant.

Examples of nonionic surfactants include polyoxyethylene alkyl ethers (such as, lauryl, cetyl, stearyl or octyl), polyoxyethylene alkylphenol ethers, polyoxyethylene lauryl ethers, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, alkyl glucosides, alkyl polyglucosides, polyoxyalkylene glycol modified polysiloxane surfactants, polyoxyalkylene-substituted silicones (rake or ABn types), silicone alkanolamides, silicone esters, silicone glycosides, dimethicone copolyols, fatty acid esters of polyols, for instance sorbitol and glyceryl mono-, di-, tri- and sesqui-oleates and stearates, glyceryl and polyethylene glycol laurates; fatty acid esters of polyethylene glycol (such as polyethylene glycol monostearates and monolaurates), polyoxyethylenated fatty acid esters (such as stearates and oleates) of sorbitol, and combinations thereof. Polyoxyalkylene silicone surfactants are known in the art and are commercially available, e.g., DOWSIL™ 502W and DOWSIL™ 67 Additive are commercially available from Dow Silicones Corporation of Midland, Michigan, USA.

Alternatively, the surfactant e) may comprise, alternatively may be, an amphoteric surfactant. Examples of amphoteric surfactants include amino acid surfactants, betaine acid surfactants, N-alkylamidobetaines, glycine derivatives, sultaines, alkyl polyaminocarboxylates, alkylamphoacetates, and combinations thereof. These surfactants may also be obtained from other suppliers under different tradenames.

The additional surfactant e) may be included in the composition in various concentrations, e.g. depending on the particular form thereof, the particular species selected for the additional surfactant e), the loading/active amounts of salt a), siloxane cationic surfactant b), and organic cationic surfactant c), if present. However, the additional surfactant e) may be utilized in an amount of 0 to 10 weight parts per 1 weight part of the siloxane cationic surfactant b).

The composition may optionally further comprise the rheology modifier f). The rheology modifier f) is not particularly limited, and is generally selected to alter the viscosity, flow property, and/or a foaming property (i.e., foam-forming ability and/or foam stability) of the composition, or an end-use composition comprising the same. As such, the rheology modifier f) is not particular limited, and may comprise a thickener, stabilizer, viscosity modifier, thixotropic agent, or combinations thereof, which will be generally selected from natural or synthetic thickening compounds. Alternatively, the rheology modifier f) may comprise one or more water soluble and/or water compatible thickening compounds (e.g. water-soluble organic polymers).

Examples of compounds suitable for use in or as the rheology modifier f) include acrylamide copolymers, acrylate copolymers and salts thereof (e.g. sodium polyacrylates), celluloses (e.g. methylcelluloses, methylhydroxypropylcelluloses, hydroxyethylcelluloses, hydroxypropylcelluloses, polypropylhydroxyethylcelluloses, and carboxymethylcelluloses), starches (e.g. starch and hydroxyethylstarch), polyoxyalkylenes (e.g. PEG, PPG, and PEG/PPG copolymers), carbomers, alginates (e.g. sodium alginate), various gums (e.g. arabic gums, cassia gums, carob gums, scleroglucan gums, xanthan gums, gellan gums, rhamsan gums, karaya gums, carrageenan gums, and guar gums), cocamide derivatives (e.g. cocamidopropyl betaines), medium to long-chain alkyl and/or fatty alcohols (e.g. cetearyl alcohol and stearyl alcohol), gelatin, saccharides (e.g. fructose, glucose, and PEG-120 methyl glucose diolate), and combinations thereof.

Alternatively, the composition may comprise the pH control agent g). The pH control agent g) is not particular limited, and may comprise or be any compound suitable for modifying or adjusting the pH of the composition and/or maintaining (e.g. regulating) the pH of the composition in a particular range. As such, as will be understood by those of skill in the art, the pH control agent g) may comprise, alternatively may be a pH modifier (e.g. an acid and/or a base), a pH buffer, or a combination thereof, such as any one or more of those described below.

Examples of acids generally include mineral acids (e.g. hydrochloric acid, phosphoric acid, and sulfuric acid), organic acids (e.g. citric acid), and combinations thereof. Examples of bases generally include alkali metal hydroxides (e.g. sodium hydroxide and potassium hydroxide), carbonates (e.g. alkali metal carbonate salts such as sodium carbonate), phosphates, and combinations thereof.

In certain embodiments, the pH control agent g) comprises, alternatively is, the pH buffer. Suitable pH buffers are not particularly limited, and may comprise, alternatively may be, any buffering compound capable of adjusting the pH of the composition and/or maintaining (e.g. regulating) the pH of the composition in a particular range. As will be understood by those of skill in the art, examples of suitable buffers and buffering compounds may overlap with certain pH modifiers, including those described above, due to the overlap in functions between the additives. As such, when both are utilized in or as the pH control agent g), the pH buffer and the pH modifier may be independently or collectively selected in view of each other.

In general, suitable pH buffers are selected from buffering compounds that include an acid, a base, or a salt (e.g. comprising the conjugate base/acid of an acid/base). Examples of buffering compounds generally include alkali metal hydroxides (e.g. sodium hydroxide and potassium hydroxide), carbonates (e.g. sesquicarbonates, alkali metal carbonate salts such as sodium carbonate), borates, silicates, phosphates, imidazoles, citric acid, sodium citrate, combinations thereof. Examples of some pH buffers include citrate buffers, glycerol buffers, borate buffers, phosphate buffers, and combinations thereof (e.g. citric acid-phosphate buffers). As such, some examples of particular buffering compounds suitable for use in or as the pH buffer of the pH control agent g) include ethylenediaminetetraacetic acids (e.g. disodium EDTA), triethanolamines (e.g. tris(2-hydroxyethyl)amine), citrates and other polycarboxylic acid-based compounds, and combinations thereof. [00%] The composition may optionally further comprise the foam enhancer h). Particular compounds/compositions suitable for use in or as the foam enhancer h) are not limited, and generally include those capable of imparting, enhancing, and or modifying a foaming property (e.g. foamability, foam stability, foam drainage, foam spreadability, and/or foam density) of the composition, or an end-use composition comprising the same. As such, one of skill in the art will readily appreciate that compounds/compositions suitable for use in or as the foam enhancer h) may overlap with those described herein with respect to other additives/starting materials of the composition.

For example, in certain embodiments, the foam enhancer h) comprises a stabilizing agent selected from electrolytes (e.g. alkali metal and/or alkaline earth salts of various anions, such as chloride, borate, citrate, and/or sulfate salts of sodium, potassium, calcium, and/or magnesium, and aluminum chlorohydrates), polyelectrolytes (e.g. hyaluronic acid salts, such as sodium hyaluronates), polyols (e.g. glycerine, propylene glycols, butylene glycols, and sorbitols), hydrocolloids, and combinations thereof.

Alternatively, the foam enhancer h) may comprise a saccharide compound, i.e., a compound comprising at least one saccharide moiety. It is to be appreciated that the term “saccharide” may be used synonymously with the term “carbohydrate” under general circumstances, and terms like “sugar” under more specific circumstances. As such, the nomenclature of any particular saccharide is not exclusionary with regard to suitable saccharide compounds for use in or as the foam enhancer h). Rather, as will be understood by those of skill in the art, suitable saccharide compounds may include, alternatively may be, any compound comprising a moiety that can be described as a saccharide, carbohydrate, sugar, starch, cellulose, or a combination thereof. Likewise, any combination of more than one saccharide moiety in the saccharide compounds may be described in more descriptive terms. For example, the term “polysaccharide” may be used synonymously with the term “glycoside,” where both terms generally refer to a combination of more than one saccharide moiety (e.g. where the combination of saccharide moieties are linked together via a glycosidic linkage and collectively form a glycoside moiety). One of skill in the art will appreciate that terms such as “starch” and “cellulose” may be used to refer to such combinations of saccharide moieties under specific circumstances (e.g. when a combination of more than one saccharide moiety in the saccharide compound conforms to the structure known in the art as a “starch” or a “cellulose”).

Examples of saccharide compounds suitable for use in or as the foam enhancer h) may include compounds, or compounds comprising at least one moiety, conventionally referred to as a monosaccharide and/or sugar (e.g. pentoses (i.e., furanoses), such as riboses, xyloses, arabinoses, lyxoses, fructoses, and hexoses (i.e., pyranoses), such as glucoses, galactoses, mannoses, guloses, idoses, taloses, alloses, and altroses), a disaccharide (e.g. sucroses, lactoses, maltoses, and trehaloses), an oligosaccharide (e.g. malto-oligosaccharides, such as maltodextrins, arafinoses, stachyoses, and fructooligosaccharides), a polysaccharide (e.g. celluloses, hemicelluloses, pectins, glycogens, hydrocolloids, starches such as amyloses, and amylopectins), or a combination thereof.

Other examples of foam enhancers suitable for use in or as the foam enhancer h) are known in the art. For example, the foam enhancer h) may comprise a polymeric stabilizer, such as those comprising a polyacrylic acid salt, a modified starch, a partially hydrolyzed protein, a polyethyleneimine, a polyvinyl resin, a polyvinyl alcohol, a polyacrylamides, a carboxyvinyl polymer, a fatty acid such as myristic acid or palmitic, or combinations thereof. Alternatively, the foam enhancer h) may comprise a thickener, such as those comprising one or more gums (e.g. xanthan gum), collagen, galactomannans, starches, starch derivatives and/or hydrolysates, cellulose derivatives (e.g. methyl cellulose, hydroxypropylcellulose, hydroxyethyl cellulose, and hydroxypropyl methyl cellulose), polyvinyl alcohols, vinylpyrrolidone-vinylacetate-copolymers, polyethylene glycols, polypropylene glycols, or a combination thereof.

The composition may comprise one or more additional components/additives, i.e., other than those described above, which are known in the art and will be selected based on the particular starting materials utilized in the composition and a desired end-use thereof. For example, the composition may comprise: a filler; a filler treating agent; a surface modifier; a binder; a compatibilizer; a colorant (e.g. a pigment or dye); an anti-aging additive; a flame retardant; a corrosion inhibitor; a UV absorber; an anti-oxidant; a light-stabilizer; a heat stabilizer; and combinations thereof. However, the composition described above may be free of perfluoroalkyl surfactants. Alternatively, the composition may be free of perfluoroalkyl substances. Furthermore, the composition may be free of anionic surfactants.

### Method of Making the Composition

The composition may be prepared by combining starting materials comprising the salt a) and the siloxane cationic surfactant b), as well as any optional starting materials (e.g. c)-h) described above), in any order of addition, optionally with a master batch, and optionally under mixing.

Alternatively, the composition may be prepared by pre-mixing the siloxane cationic surfactant b) with an optional starting material to prepare an intermediate composition that is subsequently combined with the salt a) to prepare the composition. Alternatively, the composition may be prepared by pre-mixing the salt a) with an optional starting material to prepare an intermediate composition that is subsequently combined with the siloxane cationic surfactant b) to prepare the composition. For example, the siloxane cationic surfactant b) may be combined with the pH control agent to prepare a siloxane cationic surfactant composition, which is subsequently combined with the salt a), or e.g., an aqueous solution of the salt a), to prepare the composition. Alternatively, the pH control agent is a mineral acid (e.g. HCl) and utilized in an amount sufficient to protonate some, but not all, amine groups of the siloxane cationic surfactant b), thereby preparing the siloxane cationic surfactant composition as a buffer solution. Alternatively, when the organic cationic surfactant c) is used, the organic cationic surfactant c) may be combined with the pH control agent to prepare an organic cationic surfactant composition, which is subsequently combined with the salt a) and the siloxane cationic surfactant b) (e.g. independently or in the form of the siloxane cationic surfactant composition) to prepare the composition. The pH control agent may be a mineral acid (e.g. HCl) utilized in an amount sufficient to protonate some, but not all, amine groups of the organic cationic surfactant c), thereby preparing the organic cationic surfactant composition as a buffer solution. One of skill in the art will appreciate that the pH control agent may comprise multiple functions, such as to adjust the pH of one or more individual starting materials of the composition, to buffer one or more intermediate compositions, and/or to modify, control, and/or buffer the pH of the composition by itself or in combination with one or more other starting materials.

The foam stabilizing composition may be prepared as a concentrate, e.g. via combining the salt a) and the siloxane cationic surfactant b), optionally together with any of starting materials c) to h), but with minimal amount of water. Alternatively, the foam stabilizing composition may be prepared by combining the siloxane cationic surfactant b), and water containing dissolved salt a) (e.g., sea water), and when present one or more of c) to h). If solvent is used to facilitate mixing and/or dispersion of starting materials a) and b), then all or a portion of the solvent may be removed to prepare the concentrate. Alternatively, the composition may comprise water in an amount of 1 weight part to 100 weight parts of water, per 1 weight part of the salt a).

The foam stabilizing composition may be formulated as a foam-forming composition (e.g. via diluting the composition, as described above, with a starting material comprising water, e.g., sea water) or utilized as an additive to prepare a foam-forming composition (e.g. via combining the foam stabilizing composition with a base formulation, i.e., a formulation comprising foaming agents, solvents/carriers, additives, or a combination thereof). For example, the foam-forming composition can be prepared by providing water (e.g. as an active flow from a hose or pipe or in a reaction vessel/reactor), optionally combined with one or more foam additives, and combining the foam stabilizing composition with the water (e.g. as a pre-formed mixture, via addition individual starting materials a), b), and water, and when present one or more of c) to h)). In either of such instances, the foam-forming composition comprising the foam stabilizing composition, once prepared, may be aerated or otherwise expanded (e.g. via foaming equipment or application to an aerated water stream/flow) to form a foam composition (i.e., a “foam”).

The foam prepared with the foam stabilizing composition is suitable for use in various applications. For example, as introduced above, the composition may be utilized in firefighting applications, e.g., extinguishing, suppressing, and/or preventing fire. In particular, due to the increased stability provided by the composition, foams prepared therewith may be used for extinguishing fires involving chemicals with low boiling points, high vapor pressures, and/or limited aqueous solubility (e.g. gasoline and/or organic solvents), which are typically extremely flammable and/or difficult to extinguish and/or prevent reignition. For example, such a fire may be extinguished by contacting the fire with foam (e.g. by spraying the foam onto the fire or spraying the foam-forming composition over the fire to prepare the foam thereon). In similar fashion, the foam may be utilized to secure chemicals (e.g. from a spill or leak thereof) to limit vapor leak and/or ignition, by the applying the foam to the top of the spill/leak, or otherwise forming the foam thereon.

Alternatively, the foams may be produced by mechanically agitating or submitting to other conventional foam-producing methods an aqueous mixture having the same composition as the final foam. Alternatively, a foam concentrate is produced with starting materials listed from a) to h) above which is diluted with adequate amount of water (e.g., sea water) and agitated to produce an aqueous foam with the desired quality. Alternatively, the salt a) (e.g., in powder form or as an aqueous solution) may be separately mixed with a concentrate of the siloxane cationic surfactant b) and optionally one or more of starting materials c) to h) described above, and thereafter diluted with an adequate amount of water and agitated to produce an aqueous foam with the desired quality.

Without wishing to be bound by theory, it is thought that it may be beneficial to store the concentrate of the salt a) separately from the concentrate containing the siloxane cationic surfactant b), and to mix the separate concentrates at the point of application to maximize shelf-life of the foam-forming composition. The finished foam may then be dispensed upon a polar fuel and/or a hydrocarbon fuel fire.

### Examples

These examples are intended to illustrate the invention to one skilled in the art and are not to be construed to limit the scope of the invention set forth in the claims. Starting materials used in these examples are summarized below.

TABLE 1
Starting Materials

| Name | Label | Description |
|---|---|---|
| Si4PrN-QUAB | S1 | Cationic silicone surfactants prepared |
| | | according to Reference Example 1 |
| Si4PrPDA-(QUAB)2 | S2 | Cationic silicone surfactants prepared |
| | | according to Reference Example 2 |
| Si10PrPDA-QUAB | S3 | Cationic silicone surfactants prepared |
| | | according to Reference Example 3 |
| Si10PrPDA-(QUAB)2 | S4 | Cationic silicone surfactants prepared |
| | | according to Reference Example 4 |
| N,N-diethyl-4-(3- | S5 | Cationic silicone surfactants prepared |
| (1,1,1,3,5,5,5- | | according to Reference Example 9 |
| heptamethyltrisiloxan-3- | | |
| yl)propoxy)-2-hydroxy- | | |
| N-methylbutan-1- | | |
| aminium iodide | | |
| pH Control Agent | | 2N hydrochloric acid (HCl) |
| Si 10PrPDA | | Amine dendrimer prepared |
| | | as described below in |
| | | Reference Example 3 |
| CaCl₂ | Salt 1 | Calcium chloride from |
| | | Fisher Scientific |
| MgCl₂ | Salt 2 | Magnesium chloride from |
| | | Sigma-Aldrich |
| AlCl₃ | Salt 3 | Aluminum chloride from |
| | | Sigma-Aldrich |
| ZnCl₂ | Salt 4 | Zinc chloride from |
| | | Sigma-Aldrich |
| NaCl | Salt 5 | Sodium chloride from |
| | | Sigma-Aldrich |
| KCl | Salt 6 | Potassium chloride from |
| | | Sigma-Aldrich |
| NaBr | Salt 7 | Sodium Bromide from |
| | | Sigma-Aldrich |
| NaI | Salt 8 | Sodium Iodide from |
| | | Sigma-Aldrich |
| CaBr₂ | Salt 9 | Calcium Bromide from |
| | | Alfa Aesar |
| CaI₂ | Salt 10 | Calcium Iodide from |
| | | Alfa Aesar |
| CaSO₄ | Salt 11 | Calcium sulfate from |
| | | Sigma-Aldrich |
| EtOH | Solvent | Ethanol from |
| | | Sigma-Aldrich |
| H₂O | Diluent | Water at TDCC |
| C₇H₁₆ | Test | Heptane from Fischer |
| | Fuel | Scientific |

In this Reference Example 1, Si4-QUAB of formula:

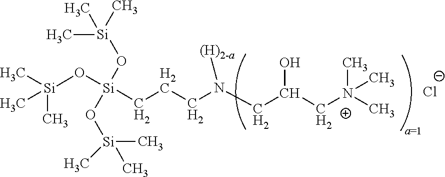

was prepared as follows: 3-aminopropyltris(trimethylsiloxy)silane (95.41 g), glycidyltrimethylammonium chloride (61.2 g; 72.7% solution in water), ethanol (89.35 g), and HCl (0.58 g; 2N) are mixed in a 3-neck round bottom flask stirred and heated to 65° C. The reaction was held at temperature for ˜2.5 hours. The solution was allowed to cool to <40° C. and then HCl (46.22 g; 2N) was added and mixed. Then DI water (107.6 g) was added to the reaction solution and mixed for ˜3 hours. The final product was 34.94% surfactant, 42.74% water, and 22.32% ethanol.

In this Reference Example 2, Si₄PrPDA-(QUAB)₂ of formula:

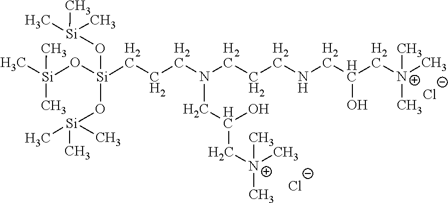

prepared as follows: 3-(propyl)propane-1,3-diaminetris(trimethylsiloxy)silane (3.34 g), glycidyltrimethylammonium chloride (3.69 g, 2.0 eq.; 72.7% solution in water), and ethanol (3.23 g) are added and mixed in a 2 oz sample vial. The reaction solution was heated to 60° C. and held at temperature for ˜10 hours. The sample was then cooled to room temperature. The final product structure was confirmed by ¹H NMR and the concentration of the solution was 58.69% surfactant, 9.83% water, and 31.48% ethanol.

In this Reference Example 3, Si₁₀PrPDA-(QUAB) of formula:

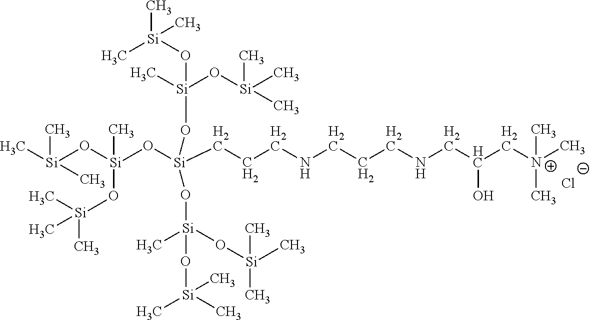

was prepared as follows: Si₁₀PrPDA (8.138 g), glycidyltrimethylammonium chloride (2.54 g, 0.58 eq.; 72.7% solution in water), and ethanol (4.54 g) are added and mixed in a 2 oz sample vial. The reaction solution was heated to 60° C. and held at temperature for ˜4 hours. The sample was then cooled to room temperature. The final product structure was confirmed by ¹H NMR and the concentration of the solution was 65.69% surfactant, 4.53% water, and 29.78% ethanol.

The Si₁₀PrPDA was prepared as follows:

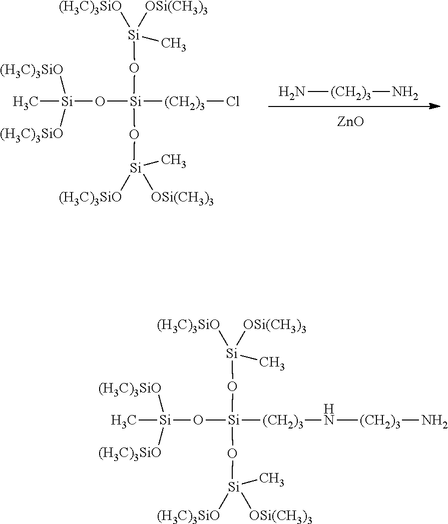

A 200 mL receiving flask is charged with Si₁₀PrCl (50 g), 1,3-diaminopropane (25 g), and ZnO (2.62 g), and then heated to and held at 140° C. for 9 hours using an oil bath. The mixture is then cooled to room temperature, filtered to remove solids, and phase separated. The top layer is collected and concentrated with a rotary evaporator (120° C.; <1 mmHg; 60 minutes) to give the product (Si₁₀PDA; nearly colorless).

In this Reference Example 4, Si₁₀PrPDA-(QUAB)₂ of formula:

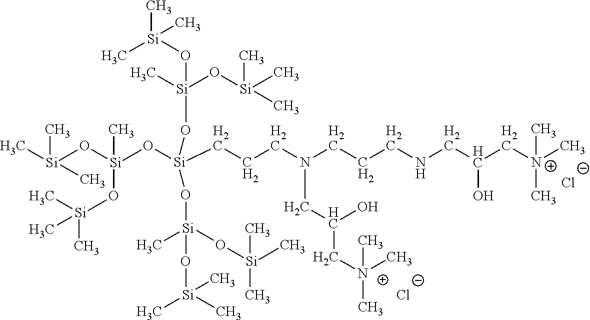

was prepared as follows: Si₁₀PrPDA (6.846 g), glycidyltrimethylammonium chloride (3.68 g, 1.08 eq.; 72.7% solution in water), and ethanol (4.54 g) were added and mixed in a 2 oz sample vial. The reaction solution was heated to 60° C. and held at temperature for ˜4.5 hours. The sample was then cooled to room temperature. The final product structure was confirmed by ¹H NMR and the concentration of the solution was 63.23% surfactant, 6.64% water, and 30.13% ethanol.

In this Reference Example 5, a cationic trisiloxane of formula:

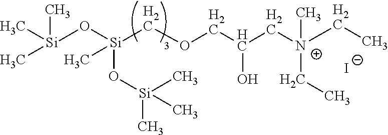

was prepared as follows: The synthesis of the cationic trisiloxane was a three step reaction. The first reaction was a hydrosilylation where 1,1,1,3,5,5,5-heptamethyltrisiloxane (62.22 g) and allyl glycidyl ether (3.74 g) was heated in a 3-neck round bottom flask to 75° C. Once at temperature, a solution in IPA of 1% Pt from Karstedt's catalyst was added. The remaining allyl glycidyl ether (47.60 g) was metered into the reaction solution, maintaining the reaction temperature at <90° C. The excess allyl glycidyl ether was removed via vacuum distillation. The resulting epoxy functional trisiloxane (7.93 g), diethylamine (5.17 g), and isopropyl alcohol (3.65 g) were added to a 2 oz sample vial, mixed and heated to 75° C. The reaction mixture was held at temperature for ˜2 hours, and then the IPA and excess diethylamine was removed using a rotary evaporator and vacuum pump. The resulting tertiary amine functional trisiloxane (7.10 g) and methyl iodine (3.12 g) were added to a 2 oz sample vial and mixed at room temperature. The reaction solution turned brown and the viscosity of the sample increased. The sample was mixed for ˜30 minutes at room temperature. The excess methyl iodine was then removed using a rotary evaporator and vacuum pump. Ethanol (2.02 g) was added to the remaining high viscosity brown solution to decrease the viscosity and produce the cationic trisiloxane solution, which was 79.8% cationic trisiloxane surfactant and 20.2% ethanol.

In this Reference Example 6: C6-QUAB of formula

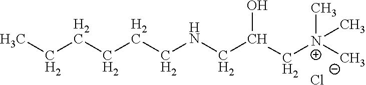

was prepared as follows:1-hexylamine (2.82 g), glycidyltrimethylammonium chloride (6.21 g; 72.7% solution in water), ethanol (5.02 g), and HCl (1.35 g; 0.1N) were mixed in a 1 oz vial and stirred on a 60° C. heating block to give a mixture, which turned clear within ˜2 minutes. The mixture was stirred for 2.5 hours, then pH Control Agent (4.69 g) was added, and the solution stirred at RT for 1 hour to give a composition comprising a cationic surfactant (C6-QUAB; 36.7% concentration).

In this Reference Example 7, of C8-QUAB of formula

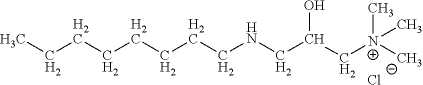

was prepared as follows: 1-octylamine (3.60 g), glycidyltrimethylammonium chloride (6.21 g; 72.7% solution in water), ethanol (5.04 g), and HCl (1.35 g; 0.1N) were mixed in a 1 oz vial and stirred on a 60° C. heating block to give a mixture, which turned clear within ˜3 minutes. The mixture was stirred for 2.5 hours, then pH Control Agent (4.76 g) was added and the solution stirred at RT for 1 hour to give a composition comprising a cationic surfactant (C8-QUAB; 38.6 wt. % concentration).

In this Reference Example 8, C10-QUAB of formula

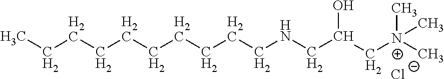

prepared as follows: 1-decylamine (4.38 g), glycidyltrimethylammonium chloride (6.19 g; 72.7% solution in water), ethanol (5.00 g), and HCl (1.35 g; 0.1N) are mixed in a 1 oz vial and stirred on a 60° C. heating block to give a mixture, which turns clear within ˜4 minutes. The mixture is stirred for 2.5 hours, then pH Control Agent (4.72 g) is added and the solution stirred at RT for 1 hour to give a composition comprising a cationic surfactant (C10-QUAB; 40.8 wt. % concentration).

In this Reference Example 9, firefighting foam samples were prepared and evaluated as follows. The starting materials used and their amounts are shown below in Tables 2A, 2B, 2C, and 2D. The results are shown below in Tables 3A, 3B, 3C, 3D, and 3E. Household foaming soap dispensers purchased on Amazon (Parker Eight, 10 oz) were used to generate foams. For foam stability measurement at room temperature, 100 ml beakers were used; for measurement on hot heptane, a flat-bottom crystallizing dish with a diameter of 100 mm and height of 50 mm was used. A digital camera (Canon Rebel T3i) with an 18-55 mm lens was used to capture images of the foams from the side of the container at fixed time intervals to visualize the dynamics of foam collapse. The light source, focus, aperture, and shutter speed were adjusted manually according to needs. For measurement at room temperature, 100 ml of foam was dispensed into the beaker and image series was recorded at 1 frame every 20 seconds. For measurement with heptane at 60° C., 40 ml of heptane was poured into the dish. The dish was heated on a hot plate to allow heptane to reach 60° C. and maintained at that temperature. Then 100 ml of foam was dispensed on top of the hot heptane and the hot plate was subsequently switched off. Image series was recorded at 1 frame every 2 seconds. The recorded images were imported in ImageJ image analysis software. A small vertical section of the foam column was cropped along the center line to minimize edge effects from the circular shape of the container; this also reduced the file size for faster computation time. The cropped images were subsequently analyzed in MATLAB to calculate the height of the foam column. The pixel intensity values were first averaged along the horizontal direction to obtain the average intensity as a function of the height of the container. Next, the ischange built-in function in MATLAB was used to find abrupt changes in the pixel intensities in the vertical direction to locate the “top” and “bottom” coordinates of the foam column. These coordinates were then subtracted from each other to calculate the total height of the foam. The procedure was repeated for each image in the series to evaluate the foam height as a function of time. Foam height at time=0 (first image) was subtracted from the heights measured in subsequent images to calculate the % change in foam height as a function of time. Foam stability in Tables 3A, 3B, and 3C are expressed as time take for 50% of the foam column to collapse.

TABLE 2A
Inventive Compositions with surfactant S1 and Metal Chloride Salts.

| Starting | SI | | | | | | | | | | |
|---|---|---|---|---|---|---|---|---|---|---|---|
| Material | Units | IE1 | IE2 | IE3 | IE4 | IE5 | IE6 | IE7 | IE8 | IE9 | IE10 |
| Cationic | g | 0.60 | 0.60 | 0.60 | 0.60 | 0.60 | 0.60 | 0.60 | 0.60 | 0.60 | 0.60 |
| silicone | | | | | | | | | | | |
| surfactant, S1 | | | | | | | | | | | |
| Cationic | g | 1.00 | 1.00 | 1.00 | 1.00 | 1.00 | 1.00 | 1.00 | 1.00 | 1.00 | 1.00 |
| hydrocarbon | | | | | | | | | | | |
| surfactant | | | | | | | | | | | |
| Salt 1 | g | 0.56 | — | — | 1.66 | — | — | — | 3.33 | — | 5.50 |
| Salt 2 | g | — | 0.48 | — | — | 1.43 | — | — | — | 2.86 | — |
| Salt 3 | g | — | — | 0.49 | — | — | — | — | — | — | — |
| Salt 4 | g | — | — | — | — | — | — | — | — | — | — |
| Salt 5 | g | — | — | — | — | — | 3.36 | — | — | — | — |
| Salt 6 | g | — | — | — | — | — | — | 3.36 | — | — | — |
| Solvent | g | 0.84 | 0.84 | 0.84 | 0.84 | 0.84 | 0.84 | 0.84 | 0.84 | 0.84 | 0.84 |
| Diluent | g | 97.01 | 97.08 | 97.07 | 95.9 | 96.13 | 94.20 | 94.20 | 94.23 | 94.71 | 92.06 |
| R | | 0.35 | 0.30 | 0.30 | 1.04 | 0.90 | 2.10 | 2.10 | 2.08 | 1.78 | 3.44 |

TABLE 2B
Comparative Compositions with surfactant S1 and Metal Chloride, Bromide, and Iodide Salts.

| Starting | SI | | | | | | | | | | | | | | |
|---|---|---|---|---|---|---|---|---|---|---|---|---|---|---|---|
| Material | Units | CE1 | CE2 | CE3 | CE4 | CE5 | CE6 | CE7 | CE8 | CE9 | CE10 | CE11 | CE12 | CE13 | CE14 |
| Cationic | g | 0.60 | 0.60 | 0.60 | 0.60 | 0.60 | 0.60 | 0.60 | 0.60 | 0.60 | 0.60 | 0.60 | 0.60 | 0.60 | 0.60 |
| silicone | | | | | | | | | | | | | | | |
| surfactant, S1 | | | | | | | | | | | | | | | |
| Cationic | g | 1.00 | 1.00 | 1.00 | 1.00 | 1.00 | 1.00 | 1.00 | 1.00 | 1.00 | 1.00 | 1.00 | 1.00 | 1.00 | 1.00 |
| hydrocarbon | | | | | | | | | | | | | | | |
| surfactant | | | | | | | | | | | | | | | |
| Salt 1 | g | — | — | 0.06 | — | — | — | — | — | — | — | — | — | — | — |
| Salt 2 | g | — | — | — | 0.06 | — | — | — | — | — | — | — | — | — | — |
| Salt 3 | g | — | — | — | — | 0.04 | — | — | 1.34 | — | — | — | — | — | — |
| Salt 4 | g | — | 0.07 | — | — | | 0.68 | 2.05 | — | — | — | — | — | — | — |
| Salt 5 | g | — | — | — | — | — | — | — | — | 1.76 | — | — | — | — | — |
| Salt 6 | g | — | — | — | — | — | — | — | — | — | 2.24 | — | — | — | — |
| Salt 7 | g | — | — | — | — | — | — | — | — | — | — | 4.63 | — | — | — |
| Salt 8 | g | — | — | — | — | — | — | — | — | — | — | — | 6.75 | — | — |
| Salt 9 | g | — | — | — | — | — | — | — | — | — | — | — | — | 3.00 | — |
| Salt 10 | g | — | — | — | — | — | — | — | — | — | — | — | — | — | 4.41 |
| Solvent | g | 0.84 | 0.84 | 0.84 | 0.84 | 0.84 | 0.84 | 0.84 | 0.84 | 0.84 | 0.84 | 0.84 | 0.84 | 0.84 | 0.84 |
| Diluent | g | 97.56 | 97.49 | 97.50 | 97.50 | 97.52 | 96.89 | 95.52 | 96.22 | 95.81 | 95.33 | 92.93 | 90.82 | 94.56 | 93.15 |
| R | | 0.00 | 0.04 | 0.04 | 0.04 | 0.03 | 0.42 | 1.28 | 0.84 | 1.10 | 1.40 | 2.89 | 4.22 | 1.87 | 2.76 |

TABLE 2C
Formulation table 3. Compositions with surfactant S2, S4, and S5 and Metal Chloride Salts.

| Ingredient | SI | | | | | | | | | | | |
|---|---|---|---|---|---|---|---|---|---|---|---|---|
| Type | Units | CE15 | IE11 | IE12 | IE13 | CE16 | IE14 | IE15 | IE16 | CE17 | IE17 | IE18 |
| Cationic | g | 0.30 | 0.30 | 0.30 | 0.30 | — | — | — | — | — | — | — |
| silicone | | | | | | | | | | | | |
| surfactant, S2 | | | | | | | | | | | | |
| Cationic | | — | — | — | — | 0.30 | 0.30 | 0.30 | 0.30 | — | — | — |
| silicone | | | | | | | | | | | | |
| surfactant, S4 | | | | | | | | | | | | |
| Cationic | | — | — | — | — | — | — | — | — | 0.30 | 0.30 | 0.30 |
| silicone | | | | | | | | | | | | |
| surfactant, S5 | | | | | | | | | | | | |
| Cationic | g | 0.50 | 0.50 | 0.50 | 0.50 | 0.50 | 0.50 | 0.50 | 0.50 | 0.50 | 0.50 | 0.50 |
| hydrocarbon | | | | | | | | | | | | |
| surfactant | | | | | | | | | | | | |
| Salt 1 | g | — | 1.67 | — | — | — | 1.66 | — | — | — | 1.66 | — |
| Salt 2 | g | — | — | 1.43 | — | — | — | 1.43 | — | — | — | 1.43 |
| Salt 5 | g | — | — | — | 1.31 | — | — | — | 1.31 | — | — | — |
| Solvent | g | 0.39 | 0.39 | 0.39 | 0.39 | 0.37 | 0.37 | 0.37 | 0.37 | 0.30 | 0.30 | 0.30 |
| Diluent | g | 48.81 | 47.14 | 47.38 | 47.50 | 48.83 | 47.17 | 47.40 | 47.51 | 48.90 | 47.23 | 47.47 |
| R | | 0.00 | 2.08 | 1.79 | 1.64 | 0.00 | 2.08 | 1.79 | 1.64 | 0.00 | 2.08 | 1.79 |

TABLE 2D
Compositions with Surfactant S1, and Metal Sulfate Salt.

| Ingredient Type | SI Units | IE19 |
|---|---|---|
| Cationic silicone | g | 0.30 |
| surfactant, S1 | | |
| Cationic hydrocarbon | g | 0.50 |
| surfactant | | |
| Salt 11 | g | 0.14 |
| Solvent | g | 0.42 |
| Diluent | g | 48.65 |
| R | | 0.18 |

Where R is the weight ratio of salt to total surfactant concentration in the formulation

TABLE 3A
Time taken for 50% of foam column to collapse. Compositions with surfactant S1

| Anion | | | | | | | | | | | | |
|---|---|---|---|---|---|---|---|---|---|---|---|---|
| conc | Performance | Time for 50% foam collapse (min) | | | | | | | | | | |
| (mM) | Criteria | No salt | ZnCl2 | CaCl2 | MgCl2 | AlCl3 | NaCl | KCl | NaBr | NaI | CaBr2 | CaI2 |
| | >100 | CE1 | | | | | | | | | | |
| 0 | minutes | 90 | — | — | — | — | | | | | | |
| | | | CE2 | CE3 | CE4 | CE5 | | | | | | |
| 10 | | — | 46 | 52 | 45 | 55.5 | | | | | | |
| | | | CE6 | IE1 | IE2 | IE3 | | | | | | |
| 100 | | | 55 | 138 | 164.5 | 218 | | | | | | |
| | | | CE7 | IE4 | IE5 | CE8 | CE9 | CE10 | | | CE13 | CE14 |
| 300 | | — | 19.5 | >300 | 205 | 63.5 | 96 | 75 | | | 20 | 0 |
| | | | | | | | | IE7 | CE11 | CE12 | | |
| 450 | | | | | | | | 115 | 26 | 0 | | |
| | | | | | | | IE6 | | | | | |
| 575 | | — | — | — | — | — | 154 | | | | | |
| | | | | IE8 | IE9 | | | | | | | |
| 600 | | | | >300 | >300 | | | | | | | |
| | | | | IE10 | | | | | | | | |
| 1010 | | | | >300 | | | | | | | | |

TABLE 3B
Time taken for 50% of foam column to collapse.
Compositions with surfactant S2

| Anion conc | Performance | Time for 50% foam collapse (min) | | | |
|---|---|---|---|---|---|
| (mM) | Criteria | No salt | CaCl₂ | MgCl₂ | NaCl |
| | >100 minutes | CE15 | | | |
| 0 | | 95 | — | — | |
| | | | | | IE13 |
| 450 | | | | | 112 |
| | | | IE11 | IE12 | |
| 600 | | | 134 | 169 | |

TABLE 3C
Time taken for 50% of foam column to collapse.
Compositions with surfactant S4

| Anion conc | Performance | Time for 50% foam collapse (min) | | | |
|---|---|---|---|---|---|
| (mM) | Criteria | No salt | CaCl₂ | MgCl₂ | NaCl |
| | >100 minutes | CE16 | | | |
| 0 | | 74 | — | — | |
| | | | | | IE16 |
| 450 | | | | | 180 |
| | | | IE14 | IE15 | |
| 600 | | | 212 | 244 | |

TABLE 3D
Time taken for 50% of foam column to collapse.
Compositions with surfactant S5

| Anion conc | Performance | Time for 50% foam collapse (min) | | |
|---|---|---|---|---|
| (mM) | Criteria | No salt | CaCl₂ | MgCl₂ |
| | >120 minutes | CE17 | | |
| 0 | | 118 | — | — |
| | | | IE17 | IE18 |
| 600 | | | 260 | >300 |

TABLE 3E
Time taken for 50% of foam column to collapse. Compositions
with surfactant S1, and Metal Sulfate salt

| | |
|---|---|
| | Time for 50% foam |
| Performance | collapse (min) |

| Anion conc (mM) | Criteria | No salt | CaSO₄ |
|---|---|---|---|
| | >100 minutes | CE1 | |
| 0 | | 90 | |
| | | | IE19 |
| 21 | | | 192 |

The examples above show that the foam stability at room temperature improved under certain salt conditions. Certain metal salts can be added to the foam stabilizing compositions at certain concentrations. For example, ZnCl₂ (CE2,6,7) destabilized the foam at all conditions tested compared to the control foam formulation with no salt additive (CE1). However, CaCl₂ improved stability of the foam above approximately 30 mM but destabilized the foam at lower concentrations (for example at 5 mM, CE3). Compositions for various salts where improvement in foam stability was observed are as follows:
1. AlCl₃—stabilized foam in the range 12<Salt Conc (mM)<85.
2. CaCl₂)—stabilized foam in the range Salt Conc (mM)>30.
3. MgCl₂—stabilized foam in the range Salt Conc (mM)>25.
4. NaCl—stabilized foam in the range Salt Conc (mM)>320.
5. KCl—stabilized foam in the range Salt Conc (mM)>395.
6. NaBr—did not stabilize the foam at any tested concentration.
7. NaI—did not stabilize the foam at any tested concentration.
8. CaBr₂—did not stabilize the foam at any tested concentration.
9. CaI₂—did not stabilize the foam at any tested concentration.
10. CaSO₄—stabilized the foam at a Salt Conc of 21 mM.

Foam stability measurement over 60° C. heptane showed that IE4 (1.663% CaCl₂) was more stable than the control foam formulation with no salt additive (CE1). Without wishing to be bound by theory, it is thought that this enhanced foam stability may correspond to better firefighting performance of the foam. Moreover, the foam height rises more in IE4 (more than 100% change in foam height) compared to CE1 (about 70% max change in foam height). Without wishing to be bound by theory, it is thought that the increase in foam height can be tied to the foam's ability to capture fuel vapors and thus the data reveals IE4 can be more effective in suppressing heptane vapors.

Under the conditions tested in these examples, certain salts did not provide a benefit for stabilizing foams. Therefore, it is thought that high amounts of salts of Zinc (Zn) should not be intentionally added to the foam stabilizing composition for the purpose of providing stable foam. Similarly, high amounts of salts including halides other than chloride (e.g., bromides and iodides) should also not be intentionally added to the foam stabilizing composition for the purpose of providing stable foam. While the intentional addition of ions such as Zn, halides other than Cl is not considered beneficial, one skilled in the art of preparing firefighting foams will appreciate that some compositions of sea water can be used with the composition to make the firefighting foam, and sea water may contain trace amounts of these mineral ions, in which case their presence in the foam is not considered to be detrimental to the foam stability. Without wishing to be bound by theory, it is thought that that ions with the highest weight fraction in sea water such as Cl, Na, Mg, and Ca may influence the overall foam stability.

### Definitions and Usage of Terms

All amounts, concentrations, ratios, and percentages are by weight unless otherwise indicated. The amounts of all starting materials in a composition total 100% by weight. The SUMMARY and ABSTRACT are hereby incorporated by reference. The articles ‘a’, ‘an’, and ‘the’ each refer to one or more, unless otherwise indicated. The singular includes the plural unless otherwise indicated. Abbreviations are defined below in Table₄.

TABLE 4
Abbreviations

| Abbreviation | Definition |
|---|---|
| AFFF | aqueous film forming foam |
| BCF | tris(pentafluorophenyl)borane |
| ° C. | degrees Celsius |
| CTAC | cetrimonium chloride |
| DI | deionized |
| g | gram |
| ¹H NMR | Proton nuclear magnetic resonance |
| | tested as described below |
| IPA | isopropanol |
| mL or ml | milliliter |
| mm | millimeter |
| mmHg | millimeter of mercury |
| nm | nanometer |
| oz | ounce |
| PFAS | perfluoroalkyl substances |
| ppm | parts per million |
| RPM | revolutions per minute |
| RT | Room temperature of 23° C. ± 2° C. |
| TDCC | The Dow Chemical Company |
| | of Midland, Michigan, USA |

The ¹H NMR analysis method used to analyze the synthesized examples is as follows: The 1H NMR samples were prepared for analysis by adding the desired compound to a sample vial and diluting it ˜10× in a deuterated NMR solvent such as deuterated chloroform or deuterium oxide. The solution was then mixed with a vortex mixer and pipetted into a 5 mm NMR tube. The 1H NMR samples were analyzed on an Agilent 400-MR NMR spectrometer at 400 MHz, equipped with a 5 mm OneNMR probe. The 1H NMR data analysis was performed using MNova from Mestrelab Research (Version 12.0.4-22023).

1. A foam stabilizing composition comprising:
(a) a salt comprising a metal and an ion selected from the group consisting of a chloride ion and a sulfate ion, where the salt is selected from the group consisting of
(a1) the metal is in Group 13, the ion is the chloride ion, and the salt is present in an amount sufficient to provide the chloride ion in a concentration >10 mM to <300 mM;
(a2) the metal is in Group 2, the ion is the chloride ion, and the salt is present in an amount sufficient to provide the chloride ion in a concentration >10 mM;
(a3) the metal is in Group 1, the ion is the chloride ion, and the salt is present in an amount sufficient to provide the chloride ion in a concentration >300 mM; and
(a4) the metal is in Group 1, Group 2 or Group 13, the ion is the sulfate ion, and the salt is present in an amount sufficient to provide the sulfate ion in a concentration of ≥10 mM;
(b) a siloxane cationic surfactant having general formula (I):
[Z¹-D¹-N(Y)ₐ(R)₂₋ₐ]^{+y}[X^{-x}]ₙ (I),
where Z¹ is a siloxane moiety; D¹ is a divalent linking group; R is H or an unsubstituted hydrocarbyl group having from 1 to 4 carbon atoms; each Y has formula -D-NR¹₃⁺, where D is a divalent linking group and each R¹ is independently an unsubstituted hydrocarbyl group having from 1 to 4 carbon atoms; subscript a is 1 or 2; 1≤y≤3; X is an anion; subscript n is 1, 2, or 3; and 1≤x≤3, with the proviso that (x*n)=y;
(c) an organic cationic surfactant having general formula (II):
[Z²-D²-N(Y)_{b}(R)_{2-b}]^{+y}[X^{-x}]ₙ (II),
where Z² is an unsubstituted hydrocarbyl group; D² is a covalent bond or a divalent linking group; subscript b is 1 or 2; and each R, Y, superscript y, X, subscript n, and superscript x is independently selected and as defined above; and
(d) water.

2. The foam stabilizing composition of claim 1, where (a) the salt is selected from the group consisting of:
(a1-1) AlCl₃, in an amount sufficient to provide the chloride ion in a concentration >10 mM to <300 mM;
(a2-1) CaCl₂) in an amount sufficient to provide the chloride ion in a concentration >10 mM to maximum solubility in water,
(a2-2) MgCl₂ in an amount sufficient to provide the chloride ion in a concentration >10 mM to maximum solubility in water,
(a2-3) calcium sulfate in an amount sufficient to provide the sulfate ion in a concentration of 10 mM to maximum solubility in water;
(a3-1) NaCl in an amount sufficient to provide the chloride ion in a concentration >300 mM to maximum solubility in water, and
(a3-2) KCl in an amount sufficient to provide the chloride ion in a concentration >300 mM to maximum solubility in water.

3. The foam stabilizing composition of claim 2, where (a) the salt is selected from the group consisting of CaCl₂ and MgCl₂, in an amount sufficient to provide the chloride ion in a concentration of 100 mM to 1010 mM.

4. The foam stabilizing composition of claim 2, where (a) the salt is selected from the group consisting of NaCl and KCl, in an amount sufficient to provide the chloride ion in a concentration of 450 mM to 1010 mM.

5. The foam stabilizing composition of claim 1, where the siloxane moiety Z¹ has the formula: 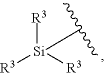
where each R³ is independently selected from R² and —OSi(R⁴)₃, with the proviso that at least one R³ is —OSi(R⁴)₃; where each R⁴ is independently selected from R², —OSi(R⁵)₃, and —[OSiR²₂]ₘOSiR²₃; where each R⁵ is independently selected from R², —OSi(R⁶)₃, and —[OSiR²₂]ₘOSiR²₃; where each R⁶ is independently selected from R² and —[OSiR²₂]ₘOSiR²₃; where 0≤n≤100; and where each R² is independently a substituted or unsubstituted hydrocarbyl group.

6. The foam stabilizing composition of claim 1, where the siloxane moiety Z¹ has one of the following structures (i)-(iv):

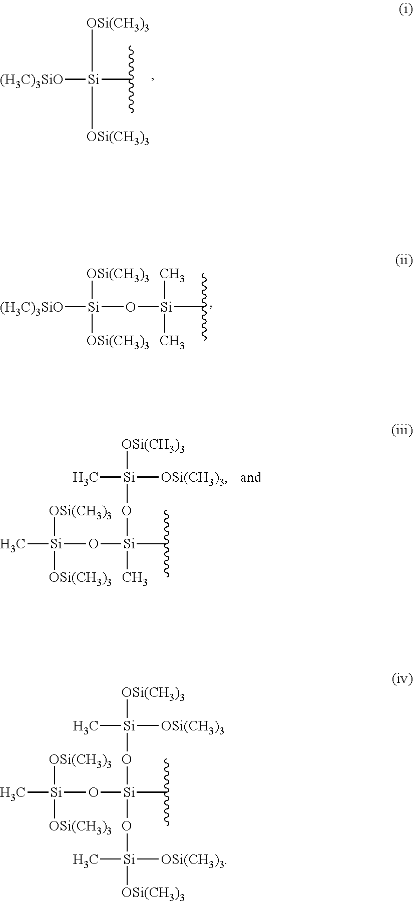

7. The foam stabilizing composition of claim 1, where: (i) D¹ is a branched or linear alkylene group; or (ii) D¹ has formula -D³-N(R⁷)-D³-, where each D³ is an independently selected divalent linking group and R⁷ is H or Y, where Y is independently selected and as defined above.

8. The foam stabilizing composition of claim 1, where in the siloxane cationic surfactant (A): (i) subscript a is 1; (ii) superscript y is 1; (iii) R is H; or (iv) any combination of (i)-(iii).

9. The foam stabilizing composition of claim 1 where: (i) each D¹ is selected from —CH₂CH(OH)CH₂—and —HC(CH₂OH)CH₂—; (ii) each R¹ is methyl; (iii) each X is Cl and superscript x is 1; or (iv) any combination of (i)-(iii).

10. The foam stabilizing composition of claim 1, where Z² is an alkyl group having from 6 to 18 carbon atoms; and where D² is selected from the group consisting of: i) the covalent bond; ii) a branched or linear alkylene group; and iii) a group of formula -D⁴-N(R⁸)-D⁴-, where each D⁴ is an independently selected divalent linking group and R⁸ is H or Y, where Y is independently selected and as defined above.

11. The foam stabilizing composition of claim 1, where in c) the organic cationic surfactant: (i) subscript b is 1; (ii) superscript y is 1; (iii) R is H; or (iv) any combination of (i)-(iii).

12. The foam stabilizing composition of claim 1, comprising a weight ratio of b) the siloxane cationic surfactant to c) the organic cationic surfactant of 1:10 to 10:1 (b:c).

13. The foam stabilizing composition of claim 1, further comprising at least one additive selected from: a carrier vehicle other than d) the water; e) a surfactant other than the siloxane cationic surfactant b) and the organic cationic surfactant c); f) a rheology modifier; g) a pH control agent; and h) a foam enhancer.

14. A firefighting foam comprising the foam stabilizing composition of claim 1, and additional water.

15. A method of extinguishing a fire comprising contacting the fire with the firefighting foam of claim 14.
